(19) United States
(12) Patent Application Publication
(10) Pub. No.: US 2015/0206224 A1
(43) Pub. Date: Jul. 23, 2015

(54) Commerce System and Method of Controlling Activity Within the Commerce System with Mapping Data Structure Supporting Intelligent Personal Agent

(71) Applicant: MyWorld, Inc., Scottsdale, AZ (US)

(72) Inventor: Kenneth J. Ouimet, Davis, CA (US)

(73) Assignee: MyWorld, Inc., Scottsdale, AZ (US)

(21) Appl. No.: 14/161,938

(22) Filed: Jan. 23, 2014

(51) Int. Cl. G06Q 30/06; G06Q 30/02

(52) U.S. Cl. CPC G06Q 30/0631; G06Q 30/0251

(57) ABSTRACT

A commerce system has retailers offering products for sale to consumers. A list including an item is provided. A set of products interchangeable with the item is determined. A product is selected from the set of products to maximize a value to a consumer. An activity within the commerce system is controlled in response to a consumer decision to purchase the selected product. A first attribute of the item is compared to a second attribute of an interchangeable product when determining the set of products. Data associated with a plurality of interchangeable products is accessed via an intelligent personal agent when determining the set of products. The selection of the product is based on a preference or a requirement defined by the consumer. The selection of the product is based on a discount associated with the product. A local retailer selling the selected product is identified when selecting the product.

### FIELD OF THE INVENTION

The present invention relates in general to consumer purchasing and, more particularly, to a commerce system and method of controlling activity within the commerce system with a mapping data structure supporting an intelligent personal agent.

### BACKGROUND OF THE INVENTION

The internet is commonly used to share information about products including pricing, photos, and ideas about how consumers are using the products. Consumers are interested in ease of shopping, quality, low prices, convenience, preparing and serving a variety of tasty meals, and receiving the most value for the money. Consumers buy many of the products they need to prepare meals to feed their families and run their homes from local retailers in business to serve those needs. Consumers choose local retailers for their shopping because consumers need convenience. Retailers need to keep consumers satisfied while earning a profit. Consumers need the best value for the money spent patronizing retailers. Years ago, a consumer phoned a neighbor to share information about a good deal on a particular product. Now, consumers and retailers share price information about a wide variety of products online. Another important consumer need is to try a variety of new foods. Years ago, a consumer shared a recipe by writing it on an index card and giving it to a relative or neighbor. Now, consumers are sharing recipes online. The internet has evolved from PC era file servers, through basic websites of the 1990's and blogs of the early 2000's, to the widgets, semantic searches, and semantic databases of today. Consumers' basic needs for convenience, value, and variety have not changed, but the way consumers meet those needs has changed. As technology changes, retailers and manufactures need to find new ways to maximize profits and market share while serving the needs of consumers. Consumers need a way to harness the latest technology of web 3.0 to simplify the shopping process, and save money.

Meeting consumers' needs profitably presents many challenges to retailers. In the retail environment, grocery stores, general merchandise stores, specialty shops, and other retail outlets face stiff competition for limited consumers and business. In the face of mounting competition and high expectations from investors, retailers must look for every advantage they can muster in maximizing market share, sales, revenue, and profit.

Manufacturers and distributors face challenges in maximizing sales and profits. Manufacturers and distributors are in a unique position because they must please both the retailers to ensure that their goods will be placed on the retailers' shelves, and the consumers to ensure the goods will later be purchased. Retailers want to stock items with a high profit margin. Consumers want to buy items with a low price. Manufacturers and distributors need new and more effective ways to reach a large audience of consumers and motivate them to stay with or switch to specific brands. The marketing strategies of manufacturers and distributors are often regional or national, rather than local. Manufacturers and distributors are seeking cost effective ways to build brand loyalty. Manufacturers and distributors are seeking internet-based solutions to their marketing problems.

Manufacturers have long realized that providing recipes featuring specific branded products increases consumer demand for those products. However, manufacturers often must do more than post a recipe to their website to motivate a consumer to go to a retailer and purchase the specific branded products. Manufactures need a way to capitalize on the internet boom in recipe sharing to increase market share of their specific branded products.

The internet, including social media websites, is now the dominant vehicle for disseminating recipes. Recipes are posted online by professional chefs, home cooks, bloggers, retailers, manufacturers, distributors, or other sources. Once posted on the internet, the potential reach of a recipe is virtually limitless. For example, one home cook from Texas uploaded a lasagna recipe, “World's Best Lasagna,” in 2001 that has been viewed nearly 12 million times, liked on a popular website more than 12,000 times, shared on another popular website more than 27,000 times, and reviewed over 10,390 times on a leading recipe website. Bloggers share recipes from various sources on their blogs. Many of the recipes contain ingredients that are unfamiliar to the consumers. Consumers read the blogs and want to try out some of these recipes but typically have difficulty locating new or unfamiliar ingredients in local grocery stores.

Consumers want to try the latest recipes from various internet sources including social media websites. Consumers want an easy way to find the ingredients from a new recipe at local retailers. Consumers also want to know they are purchasing ingredients from the retailers offering the best value for those ingredients. Recipes that are new to a consumer may have ingredients that are new or unfamiliar to the consumer. Consumers want to know which retailers stock the new ingredients, where the ingredients are located in the retailer's store, and which retailers price the new ingredients competitively.

Consumers face decision stress associated with the demands of menu planning and everyday shopping. An overwhelming number of products exist that might satisfy a want or need. An overwhelming number of possibilities exist for each meal that must be planned and served. For example, the average family spends nearly $10,000 at grocery stores in a given year. The average item at a grocery store costs $3.00; therefore, the shopper for a family makes purchasing decisions on roughly 3,000 products per year. Consumers must choose from over 3 million grocery products manufactured each year. There are dozens of major websites dedicated to food and recipes. Each has hundreds of thousands of recipes. The choices are overwhelming. As a result, consumers often purchase the same product at the same location without actually considering the alternatives. Because consumers serve the same meals to their families week after week, families are missing the opportunity to try new flavorful dishes.

Many consumers do compare multiple retailers, e.g., when shopping online, particularly for big-ticket items. Yet, the time consumers are willing to spend reviewing product information decreases rapidly with price. Little time is spent reviewing commodity items such as pasta or canned soup. In any case, the consumer has limited time to do comparative shopping, and mere searching does not constitute an optimization of the purchasing decision. Optimization requires access to more data than is readily available to the consumer.

Consumers often are faced with constraints such as budgets, product availability, and retailer locations when making purchasing decisions. The retail location where the consumer is shopping may not provide the same substitutions as competitors or may have higher pricing on desired goods. A need exists to optimize consumers' shopping lists in light of real world constraints including product availability, retailer locations, consumer preferences regarding product attributes, and pricing. A need exists to allow consumers to find ingredients from online recipes at local retailers.

In a highly competitive market, the profit margin is paper-thin and consumers and products are becoming more differentiated. Consumers are often well informed through electronic media and will have appetites only for specific products and ingredients. They want to try the latest new recipe other consumers are talking about on social media websites. Retailers, manufacturers, and distributors must understand and act upon the market segment that is tuned into their product area to make effective use of marketing dollars to capitalize on the boom in recipe sharing through social media and other websites. The retailers, manufacturers, and distributors remain motivated to optimize marketing strategy, particularly increasing brand loyalty, to maximize profit and revenue.

From the consumer's perspective, purchasing products from retailers can be expensive, time-consuming, and stressful. With limited budgets and time, consumers desire to be as efficient as possible. Consumers want to purchase familiar and unfamiliar products at the best possible price, but often do not have time to compare prices at many different retail outlets before purchasing. Consumers want to be able to locate retailers that carry unfamiliar products and specific aisle and shelf locations of those products within the retailers' establishments. Searching for the lowest price for a particular product, especially an unfamiliar product, among retailers can be a difficult task since accurate and reliable pricing data is often difficult to obtain. Additionally, the process of compiling and reviewing what little useful information is readily available to the consumer far exceeds any benefit the consumer might derive from the analysis.

### SUMMARY OF THE INVENTION

A need exists to provide a mechanism to assist consumers by determining the most valuable product options fulfilling consumer needs, including variety, from various retailers. Accordingly, in one embodiment, the present invention is a method of controlling an activity within a commerce system comprising the steps of providing a list including an item, determining a set of products interchangeable with the item, selecting a product from the set of products to maximize a value to a consumer, and controlling the activity within the commerce system in response to a decision by the consumer to purchase the selected product.

In another embodiment, the present invention is a method of controlling an activity within a commerce system comprising the steps of providing an item, determining a set of products interchangeable with the item, selecting a product from the set of products to meet a consumer satisfaction threshold, and controlling the activity within the commerce system in response to a decision by the consumer to purchase the selected product.

In another embodiment, the present invention is a method of controlling a purchasing activity comprising the steps of determining a set of products interchangeable with an item, associating a discount with each product from the set of products to create a set of discounted products, and controlling the purchasing activity by selecting a discounted product from the set of discounted products to generate a purchase by a consumer.

In another embodiment, the present invention is a computer program product usable with a programmable computer processor having a computer readable program code embodied in a non-transitory computer usable medium for controlling an activity within a commerce system comprising the steps of providing an item, determining a set of products interchangeable with the item, selecting a product from the set of products to meet a consumer satisfaction threshold, and controlling the activity within the commerce system in response to a decision by the consumer to purchase the selected product.

### BRIEF DESCRIPTION OF THE DRAWINGS

FIG. 1 illustrates a retailer engaged in commercial activity with a consumer;

FIG. 2 illustrates a commerce system with a manufacturer, distributor, retailer, and consumer;

FIG. 3 illustrates commercial transactions between consumers, manufacturers, and retailers using print add marketing;

FIG. 4 illustrates retail transactions between consumers and retailers with the aid of a consumer service provider;

FIG. 5 illustrates an electronic communication network between members of the commerce system;

FIG. 6 illustrates a computer system operating with the electronic communication network;

FIG. 7 illustrates an intelligent personal agent negotiating one to one offers between shoppers and manufacturers or retailers;

FIG. 8 illustrates retail interaction between the consumers, retailers, and consumer service provider to generate an optimized shopping list;

FIG. 9 illustrates a consumer following a link generated by a consumer service provider in response to a contributor sharing a list or a recipe;

FIG. 10 illustrates a homepage for a consumer when communicating with the consumer service provider;

FIG. 11a illustrates generally a mapping data structure determining a product set for an item of interest;

FIG. 11b illustrates an example of a mapping data structure determining a specific product set for a specific item of interest;

FIG. 12 illustrates links to consumer shopping lists;

FIG. 13 illustrates a webpage for a consumer to select product categories when creating or modifying a shopping list;

FIG. 14 illustrates a webpage for sharing lists;

FIG. 15 illustrates a search webpage for a consumer to locate preferred retailers on a map;

FIG. 16 illustrates an optimized shopping list to aid a consumer with purchasing decisions;

FIG. 17 illustrates an optimized shopping list with multiple retailers for each product;

FIG. 18 illustrates offline to online wireless list sharing;

FIG. 19 illustrates a recipe webpage for a consumer to navigate a recipe database;

FIG. 20 illustrates a specific recipe webpage for a consumer to input or prepare a recipe;

FIG. 21 illustrates an ingredient list webpage for a consumer to input ingredients for a recipe to a database;

FIG. 22 illustrates mapping data structure determining suitable products to map to an item of interest;

FIG. 23 illustrates ingredient lists, recipes, and shared lists as cell phone screen shots;

FIG. 24 illustrates a webpage for sharing recipes;

FIG. 25a illustrates generally a mapping data structure mapping ingredients from a recipe to products on a shopping list;

FIG. 25b illustrates a mapping data structure mapping ingredients from a specific recipe to specific products on a shopping list;

FIG. 26 illustrates an intelligent personal agent locating selected local products based on a shared recipe;

FIG. 27 illustrates the process of a blogger causing a reader to make an incremental purchase of a branded product using a shared list or recipe through a consumer service provider;

FIG. 28 illustrates the process of controlling activities within the commerce system by enabling a consumer to purchase a selected product; and

FIG. 29 illustrates the process of controlling purchasing activities by selecting a discounted product to generate a purchase by a consumer.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents, as may be included within the spirit and scope of the invention as defined by the appended claims and their equivalents as supported by the following disclosure and drawings.

The internet and social media are altering the way consumers shop. Trends spread rapidly and retailers must keep up with consumers' mercurial tastes. When a famous chef appears on a popular morning show and describes a new recipe for tilapia, viewers talk about it online by ten am. By noon, people who did not even watch the show have printed out a copy of the recipe, and by six, the local grocery store is sold out of tilapia. A comparative shopping service helps retailers not just keep up with trends, but harness the boom in list and recipe sharing to promote specific products and increase brand loyalty.

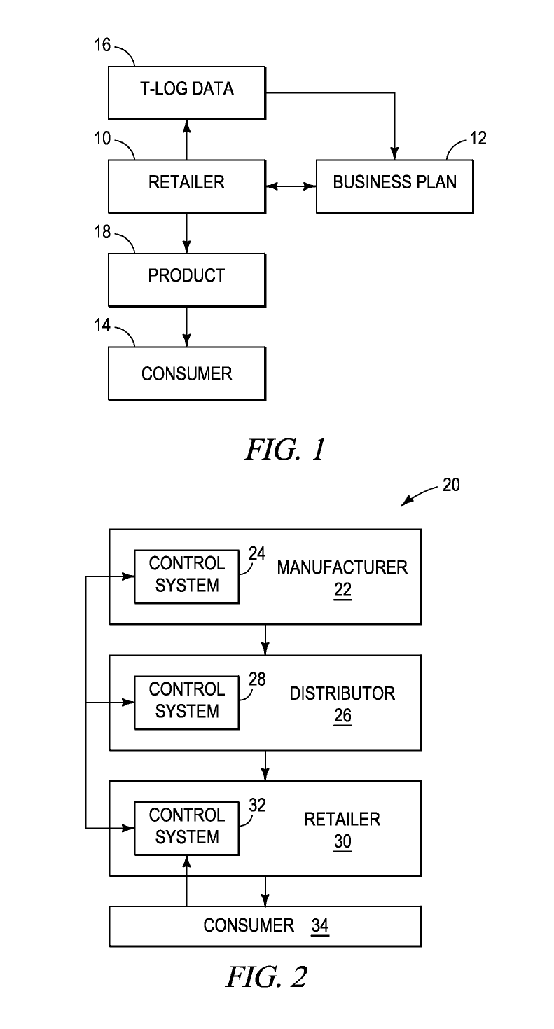

Referring to FIG. 1, retailer 10 has certain product lines or services available to consumers 14 as part of its business plan 12. The terms products 18 and services are interchangeable in the commerce system. Retailer 10 is a grocery store, general consumer product retailer, drug store, discount warehouse, department store, apparel store, specialty store, or service provider. Retailer 10 operates under business plan 12 to set pricing, order inventory, formulate and run promotions, add and remove product lines, organize product shelving and displays, select signage, hire employees, expand stores, collect and maintain historical sales data, evaluate performance and trends, and make strategic decisions. Retailer 10 changes business plan 12 as needed. While the present discussion will involve retailer 10, it is understood that the system described herein is applicable to other members in the chain of commerce, or other industries and businesses having similar goals, constraints, and needs.

Retailer 10 routinely enters into sales transactions with customer or consumer 14. Consumer 14 purchases product 18 from retailer 10. In fact, retailer 10 maintains and updates its business plan 12 to increase the number of transactions (and thus revenue and/or profit) between retailer 10 and consumer 14. Consumer 14 can be a specific individual, account, or business entity.

For each sale transaction entered into between retailer 10 and consumer 14, information is stored in transaction log (T-LOG) data 16. T-Log data 16 contains one or more line items for each retail transaction. Each line item includes information or attributes relating to the transaction, such as store number, product number, time of transaction, transaction number, quantity, current price, profit, promotion number, and consumer identity or type number. Retailer 10 also provides additional information to T-Log data 16 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-Log data 16.

FIG. 2 shows commerce system 20 involving the movement of goods between members of the system. Manufacturer 22 produces goods in commerce system 20. Manufacturer 22 uses control system 24 to receive orders, control manufacturing and inventory, and schedule deliveries. Distributor 26 receives goods from manufacturer 22 for distribution within commerce system 20. Distributor 26 uses control system 28 to receive orders, control inventory, and schedule deliveries. Retailer 30 receives goods from distributor 26 for sale within commerce system 20. Retailer 30 uses control system 32 to place orders, control inventory, and schedule deliveries with distributor 26. Retailer 30 sells goods to consumer 34. Consumer 34 patronizes retailer's establishment either in person or by using online ordering. Consumer 34 purchases are entered into control system 32 of retailer 30 as T-Log data 16.

The purchasing decisions made by consumer 34 drive the manufacturing, distribution, and retail portions of commerce system 20. More purchasing decisions made by consumer 34 for retailer 30 lead to more merchandise movement for all members of commerce system 20. Manufacturer 22, distributor 26, and retailer 30 utilize respective control systems 24, 28, and 32, to control and optimize the ordering, manufacturing, distribution, sale of the goods, and otherwise execute respective business plan 12 within commerce system 20 in accordance with the purchasing decisions made by consumer 34.

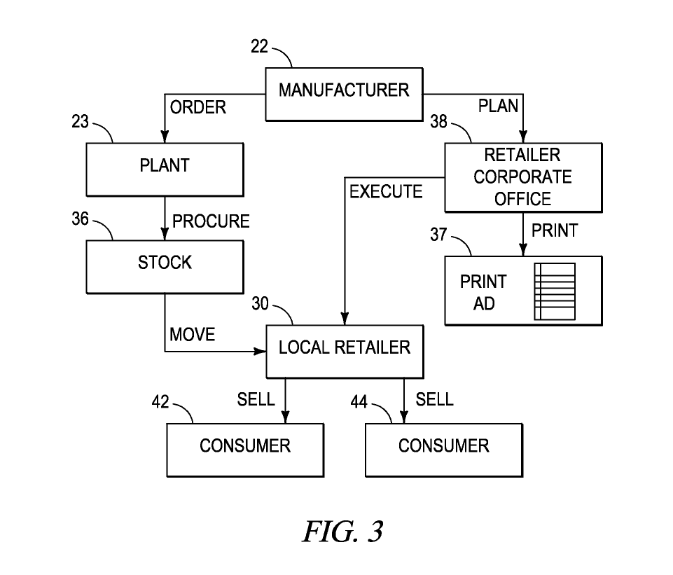

FIG. 3 shows commercial transactions between manufacturer 22 and local retailer 30 and retail transactions between local retailer 30 and consumers 42-44. Manufacturer 22 places an order for goods with plant 23. Stock 36 is procured from plant 23 and moved to local retailer 30. Local retailer 30 sells the goods to consumers 42-44. Retailer corporate office 38 receives business plans 12 from manufacturer 22 and executes the plans through local retailer 30. Retailer corporate office 38 places print adds 37 to drive consumers 42-44 to local retailer 30.

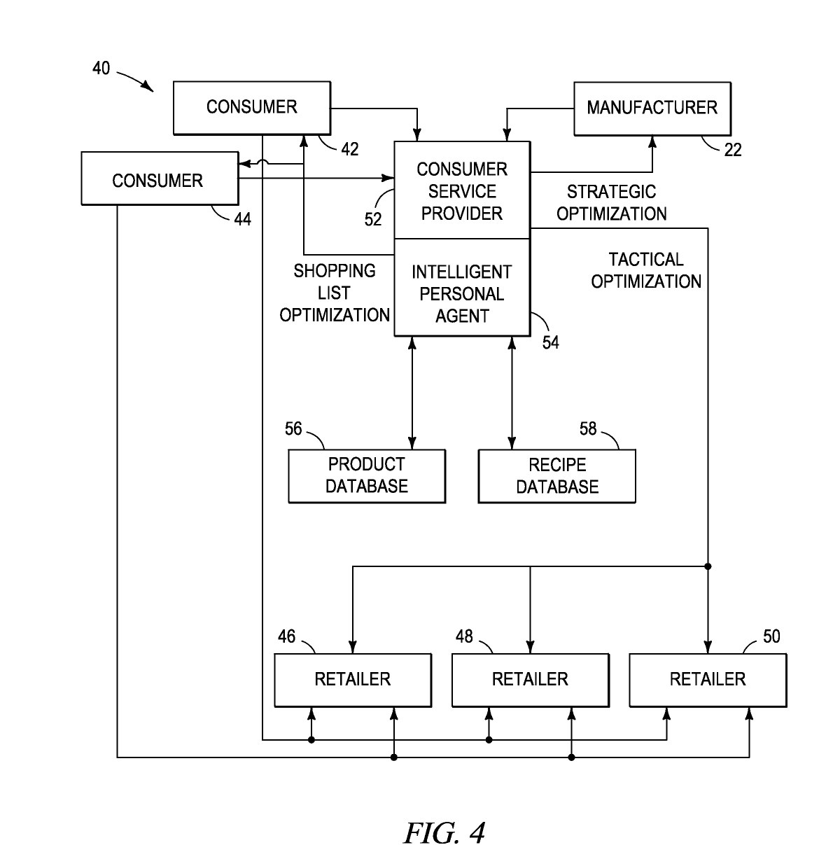

FIG. 4 shows a commerce system 40 with consumers 42-44 engaged in purchasing transactions with retailers 46-50. Retailers 46-50 are supplied by manufacturers 22 and distributors 26, as described in FIG. 2. Retailers 46-50 are typically local to consumers 42-44, i.e., retailers that consumers 42-44 are likely to patronize. Retailers 46-50 can also be remote from consumers 42-44 with transactions handled by electronic communication medium, e.g., phone or online website via personal computer or tablet, and delivered electronically or by common carrier, depending on the nature of the goods. Consumers 42-44 patronize retailers 46-50 by selecting one or more products 18 for purchase from one or more retailers 46-50. For example, consumer 42 visits the store of retailer 46 in person and selects product 18 for purchase. Consumer 42 contacts retailer 48 by phone or email and selects product 18 for purchase. Consumer 44 browses the website of retailer 50 using a personal computer, cell phone, or tablet and selects product 18 for purchase. Accordingly, consumers 42-44 and retailers 46-50 regularly engage in commercial transactions within commerce system 40.

As described herein, manufacturer 22, distributor 26, retailers 46-50, consumers 42-44, and consumer service provider 52 are considered members of commerce system 40. The retailer generally refers to the seller of product 18 and the consumer generally refers to the buyer of the product. Depending on the transaction within commerce system 40, manufacturer 22 can be the seller and distributor 26 can be the buyer, or distributor 26 can be the seller and retailers 46-50 can be the buyer, or manufacturer 22 can be the seller and consumers 42-44 can be the buyer.

A consumer service provider 52 is a part of commerce system 40. Consumer service provider 52 is a third party that assists consumers 42-44 with the product evaluation and purchasing decision process by providing access to a comparative shopping service. More specifically, consumer service provider 52 operates and maintains intelligent personal agent 54 that prioritizes product attributes and optimizes product selection according to consumer-weighted preferences. Intelligent personal agent 54 acts as a personal shopping assistant to help consumers 42-44 by giving consumers the benefit of access to data stored in product database 56, otherwise unavailable to the consumers. Intelligent personal agent 54 enables consumers 42-44 to maximize the value the consumers receive when spending their grocery budget, using the product attributes and consumer-weighted preferences stored in product database 56. Consumer service provider 52 maintains product database 56 and recipe database 58 for the benefit of consumers 42-44. Intelligent personal agent 54 provides shopping list optimization to consumers 42-44. Additionally, consumer service provider 52 provides strategic optimization to manufacturer 22 and tactical optimization to retailers 46-50. Intelligent personal agent 54 also assists consumers 42-44 with meal planning by maintaining recipe database 58. Consumers 42-44 access recipe database 58 through intelligent personal agent 54. Intelligent personal agent 54 saves consumers 42-44 considerable time and money by providing access to a comprehensive, reliable, and objective optimization model or comparative shopping service.

Each consumer 42 goes through a product evaluation and purchasing decision process each time a particular product 18 is selected for purchase. Some product evaluations and purchasing decision processes are simple and routine. For example, when consumer 42 is conducting weekly shopping in the grocery store, consumer 42 considers a needed item or item of interest, e.g., canned soup. Consumer 42 has a preferred brand, size, and flavor of canned soup. Consumer 42 selects the preferred brand, size, and flavor sometimes without consideration of price, places the item in the basket, and moves on. The product evaluation and purchasing decision process is almost automatic and instantaneous but nonetheless still occurs based on prior experiences and preferences. Consumer 42 may pause during the product evaluation and purchasing decision process and consider other canned soup options. Consumer 42 may want to try a different flavor or another brand offering a lower price. As the price of product 18 increases, the product evaluation and purchasing decision process usually becomes more involved. If consumer 42 is shopping for a big-ticket item, such as a major appliance, the product evaluation and purchasing decision process includes consideration of several manufacturers 22, visits to multiple retailers 46-50, reviews of features and warranty, talking to salespersons, reading consumer reviews, and comparing prices. In any case, understanding the approach of consumer 42 to the product evaluation and purchasing decision process is part of an effective comparative shopping service.

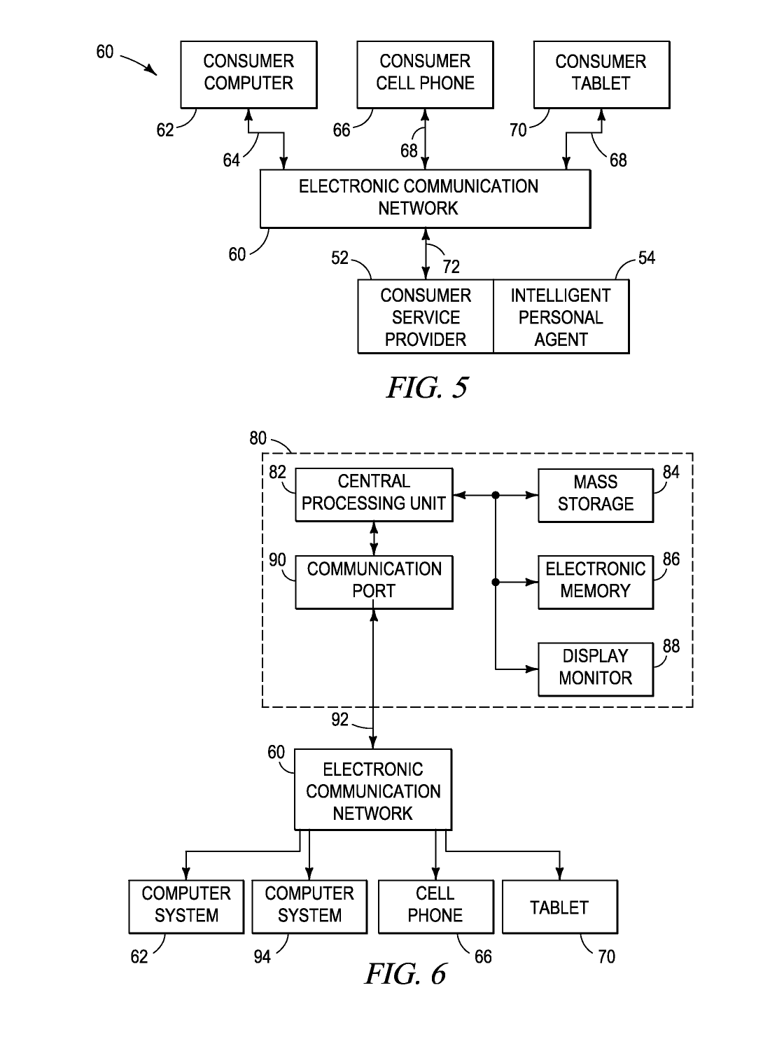

Intelligent personal agent 54 is available to consumers 42-44 and via computer-based online website or other electronic communication medium, e.g., wireless cell phone, tablet, or other personal communication device. FIG. 5 shows an electronic communication network 60 for transmitting information between consumers 42-44, consumer service provider 52, and retailers 46-50. Consumer 42 operating with computer 62 is connected to electronic communication network 60 by way of communication channel or link 64. Likewise, consumer 44 operating with a cellular telephone, smart phone, or other wireless communication device 66, or tablet 70, is connected to electronic communication network 60 by way of communication channel or link 68. Consumer service provider 52 communicates with electronic communication network 60 over communication channel or link 72. The electronic communication network 60 is a distributed network 60 of interconnected routers, gateways, switches, and servers, each with a unique internet protocol (IP) address to enable communication between individual computers, cellular telephones, tablets, electronic devices, or nodes within the network 60. In one embodiment, electronic communication network 60 is a cell phone service network. Alternatively, communication network 60 is a global, open-architecture network, commonly known as the internet. Communication channels 64, 68, and 72 are bi-directional and transmit data between computer 62, cell phone 66, tablet 70, and electronic communication network 60 in a hard-wired or wireless configuration. For example, computer 62 has email, texting, and internet capability, and consumer cell phone 66 and tablet 70 have email, mobile applications (apps), texting, and internet capability.

Further detail of the computer systems used in electronic communication network 60 is shown in FIG. 6 as a simplified computer system 80 for executing the software program used in the electronic communication process. Computer system 80 is a general-purpose computer including a processing unit or microprocessor 82, mass storage device or hard disk 84, electronic memory 86, display monitor 88, and communication port 90. Communication port 90 represents a modem, high-speed Ethernet link, wireless, or other electronic connection to transmit and receive input/output (I/O) data over communication link 92 to electronic communication network 60. Computer system or server 62 and 94 can be configured as shown for computer 80. Computer system 62 and 94, cell phone 66, and tablet 70 transmit and receive information and data over communication network 60.

Computer systems 62, 80, and 94 are physically located in any location with access to a modem or communication link to network 60. For example, computer systems 62, 80, and 94 can be located in a home or business office. Consumer service provider 52 uses computer systems 62, 80, or 94 in its business office. Alternatively, computer systems 62, 80, and 94 are mobile and accompany the user to any convenient location, e.g., remote offices, consumer locations, hotel rooms, residences, vehicles, public places, or other locales with electronic access to electronic communication network 60. Consumer 42 also accesses consumer service provider 52 by mobile app operating in cell phone 66 or tablet 70.

Each of the computers 62, 80, and 94 run application software and computer programs, which are used to display user interface screens, execute the functionality, and provide the electronic communication features as described below. The application software includes an internet browser, local email application, mobile apps, word processor, spreadsheet, and the like. In one embodiment, the screens and functionality come from the application software, i.e., the electronic communication runs directly on computer systems 62, 80, and 94. Alternatively, the screens and functions are provided remotely from one or more websites on servers within electronic communication network 60.

The software is originally provided on computer readable media, such as compact disks (CDs), external drive, or other mass storage medium. Alternatively, the software is downloaded from electronic links, such as the host or vendor website. The software is installed onto the computer system hard drive 84 and/or electronic memory 86, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a non-transitory computer program medium. Computers 62, 80, and 94 run application software to execute instructions for communication between consumers 42-44 and consumer service provider 52 to generate shopping lists and make recommendations for consumers 42-44. Cell phone 66 or tablet 70 runs one or more mobile apps to execute instructions for communication between consumers 42-44 and consumer service provider 52 which generate shopping lists and make recommendations for consumers 42-44. The application software is an integral part of the control of commercial activity within commerce system 40.

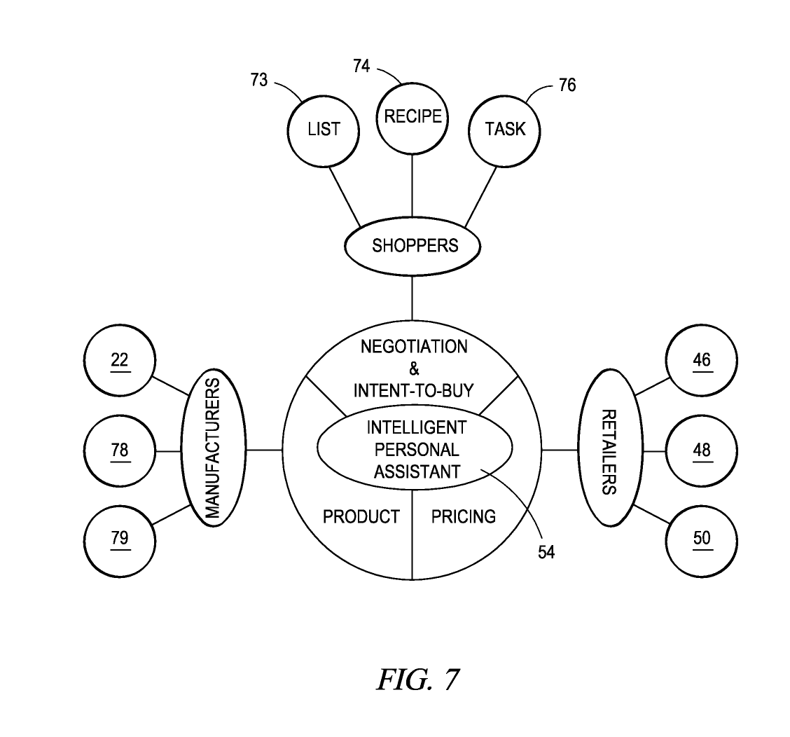

FIG. 7 shows a virtual marketplace allowing one-on-one negotiation between manufactures 22, retailers 46-50, and shoppers enabled by consumer service provider 52. Shoppers communicate lists 73, recipes 74, and tasks 76 to intelligent personal agent 54. Manufacturers 22, 78, and 79 communicate product information to intelligent personal agent 54. Retailers 46-50 communicate pricing information to intelligent personal agent 54. Intelligent personal agent 54 interprets lists 73, recipes 74, and tasks 76 data into each shopper's intent to buy. Consumer service provider 52 provides a virtual marketplace featuring price transparency and allowing intelligent personal agent 54 to conduct one-on-one negotiations of behalf of each shopper, with each manufacturer 22 and retailer 46-50.

Consumer service provider 52 assists consumer 42 in participating in the boom in list 73 and recipe 74 sharing occurring online. Consumers 42-44 value the opinions of other consumers 14 and 34 when making purchasing decisions. If consumer 14 has put effort into generating list 73 and researching options, other consumers 42-44 want to benefit from the list. Consumers 42-44 share many kinds of lists 73. A child shares list 73 of Christmas presents with grandparents. A roommate shares shopping list 73 with another roommate. A non-profit environmental group shares list 73 of spring-cleaning items consisting of renewable, earth friendly products. Intelligent personal agent 54 allows consumers 42-44 to generate and share lists 73 easily.

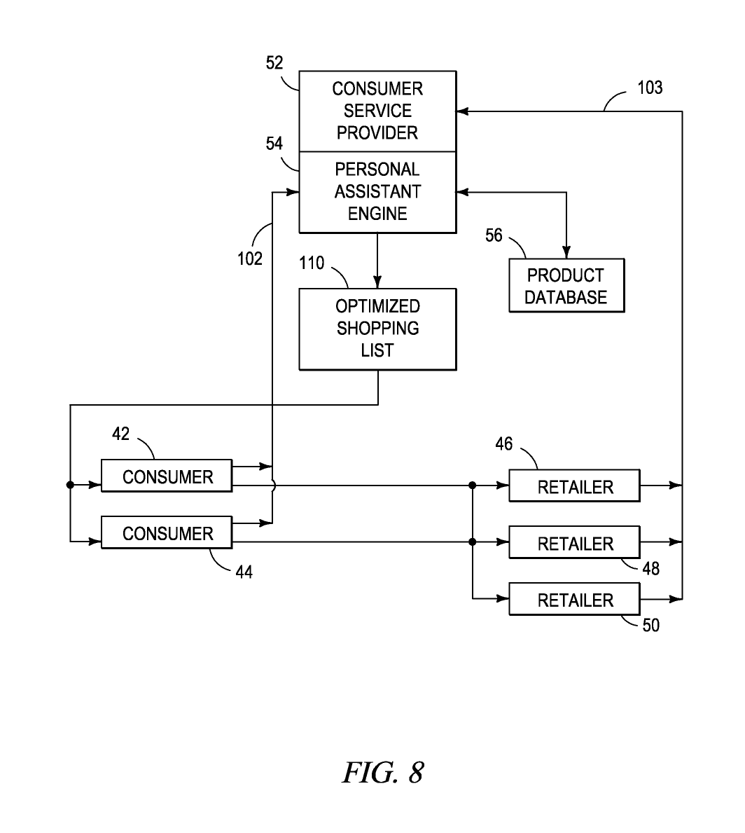

FIG. 8 shows consumers 42-44 in communication with intelligent personal agent 54 by electronic link 102. Retailers 46-50 communicate with consumer service provider 52 by electronic link 103. Intelligent personal agent 54 generates optimized shopping list 110 for consumers 42-44.

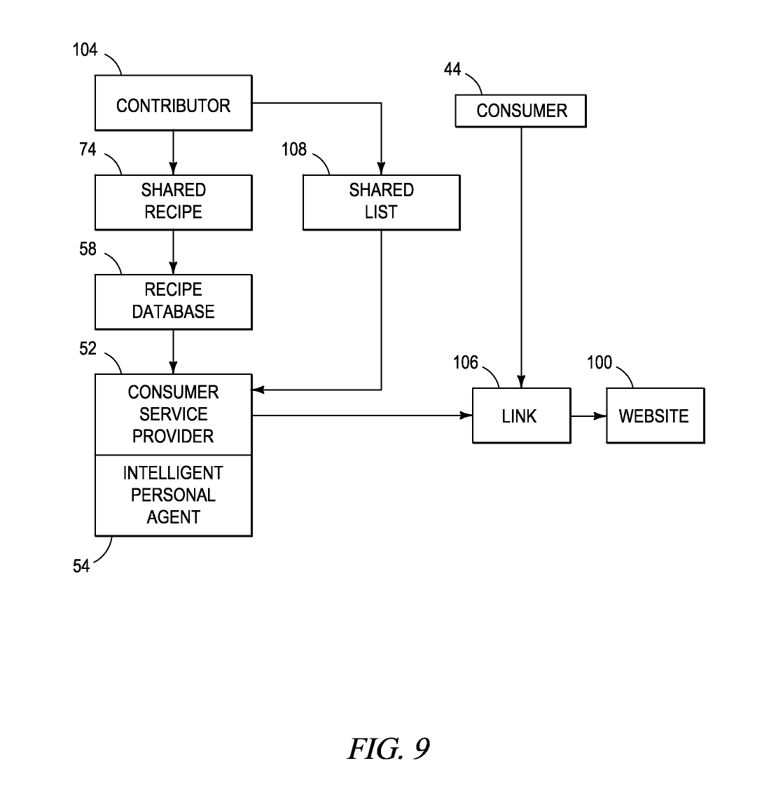

FIG. 9 shows consumer service provider 52 facilitating list and recipe sharing. Contributor 104 contributes recipes 74 to recipe database 58. Contributor 104 creates list 108. Consumer service provider 52 generates link 106 to shared list 108 or shared recipe 74. Contributor posts link 106 online. Consumer 42 accesses website 100 by selecting link 106. Website 100 is the central access point for consumer 42 to interact with consumer service provider 52 and intelligent personal agent 54. Consumer 42 accesses website 100 using computers 62, 80, and 94, cell phones 66, and tablets 70. Website 100 is optimized for viewing on computer display monitor 88, cell phone 66, and tablet 70. Consumer 42 creates an account to access all the available features on website 100. Consumer service provider 52 stores account data for consumer 42 in product database 56. Some functionality of website 100 may be available without an account.

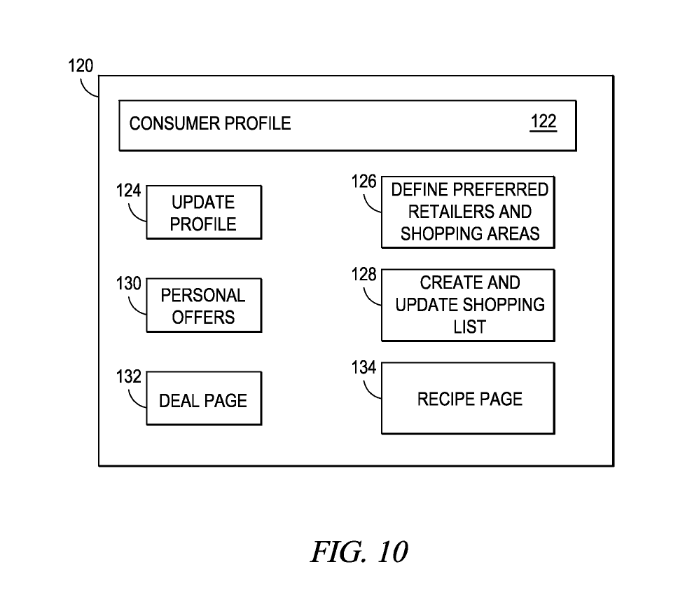

Once logged-in to website 100, consumer 42 is presented with homepage 120, as shown in FIG. 10, to launch a variety of operations and functions using one or more webpages. Block 122 shows the present consumer profile, including name, address, email address, consumer photograph, and other information. Consumer 42 changes personal information and otherwise updates the profile by selecting button 124. Consumer 42 defines preferred retailers 46-50 and shopping areas by selecting button 126, creates and updates one or more shopping lists 73 by selecting button 128, accesses personal incentives and other offers by selecting button 130, accesses a deal page by selecting button 132, and accesses a main recipe webpage by selecting button 134. Contributor 104 wants to build and share list 108 of renewable earth friendly spring-cleaning supplies. Contributor 104 logs in, creates a profile using button 124, and selects create shopping list button 128.

Before intelligent personal agent 54 can store and maintain shopping lists 73 for each consumer 42, intelligent personal agent 54 must have access to up-to-date, comprehensive, reliable, and objective retailer product information. Consumer service provider 52 maintains product database 56 with up-to-date, comprehensive, reliable, and objective retailer product information. The product information includes the product description, product attributes, regular retail pricing, and discounted offers. Consumer service provider 52 actively and continuously gathers up-to-date product information in order to maintain product database 56. In one approach to gathering product information, retailers 46-50 grant access to T-Log data 16 for use by consumer service provider 52. T-Log data 16 collected during consumer checkout is sent electronically from retailers 46-50 to consumer service provider 52.

Alternatively, consumer service provider 52 exercises a number of other data gathering approaches and sources, such as webcrawlers. Consumer service provider 52 dispatches webcrawlers to make requests for product information from websites or portals of retailers 46-50. The webcrawlers collect and return the product information to intelligent personal agent 54 for storage within product database 56. The webcrawlers navigate and parse each page of retailer websites to locate pricing and other product information. The parsing operation involves identifying and recording product description, Universal Product Code (UPC), price, ingredients, size, and other product information as recovered by the webcrawlers from retailer websites. The product information from retailer websites is sorted and stored in product database 56.

The product information in product database 56 is organized into product families based on similarity or commonality of brand, price, size, and related product attributes. Consumer service provider 52 groups products 18 into product families with common brand, size, price, or related product attribute. Product families are stored in product database 56 for each product 18.

Consumer service provider 52 groups similar or related products 18 into product families with or without the UPC. Consumer service provider 52 searches product database 56 and compares the product information for each individual product 18 to identify similar or common attributes. Product database 56 groups products 18 with common attributes together as a product family related by one or more product attributes, e.g., brand, size, price, ingredient, or additive, and differ by one or more product attributes. Mapping data structure 114 uses the product attributes stored in product database 56.

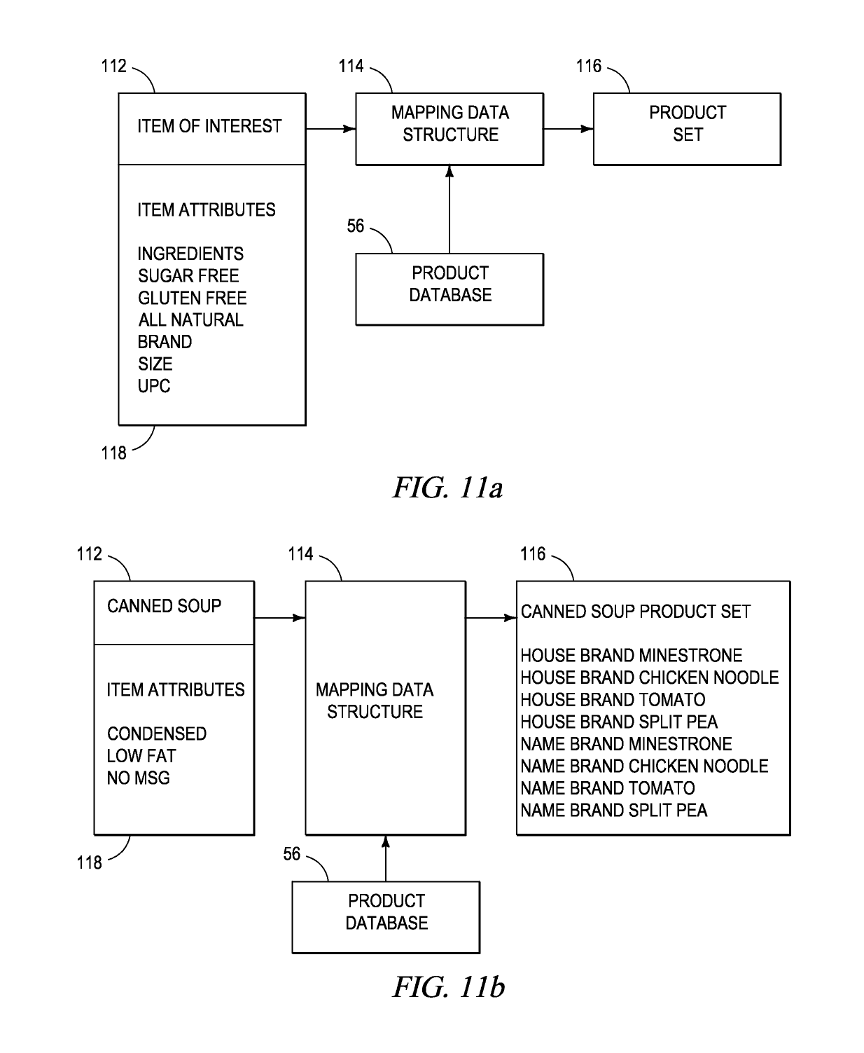

FIG. 11a shows mapping data structure 114. Consumer service provider 52 provides mapping data structure 114 for determining a specific set of products 116 interchangeable with item 112 on list 73. Product set 116 functions as a set of substitutes, alternatives, replacements, choices, or options for item 112. Products 18 in product set 116 are interchangeable for item 112. Each item 112 has associated item attributes 118. Mapping data structure 114 accesses product database 56, maintained by consumer service provider 52. Mapping data structure 114 retrieves product information for all varieties of item 112. Mapping data structure 114 uses the product attributes stored in product database 56, maintained by consumer service provider 52, to evaluate whether a given product 18 possesses the desired item attributes 118 and should be placed in product set 116 corresponding to item 112. For example, consumer 42 needs canned soup 112. Canned soup 112 has categories of item attributes 118 of brands, product lines, types, lifestyle, and sizes. Item attribute 118 of condensed is selected from the product line category. Item attribute 118 of low fat is selected from the lifestyle category. Item attribute 118 of no MSG is selected from the lifestyle category. Canned soup 112 has item attributes 118 of condensed, low fat and no MSG.

Canned soup 112 is a general item of interest. Each actual variety of canned soup, i.e., house brand condensed chicken noodle soup in a 10.5-ounce can, is a specific product 18. Mapping data structure 114 places varieties of canned soup that possess the desired item attributes 118 of condensed, low fat, and no MSG in canned soup product set 116. Mapping data structure 114 does not place varieties of canned soup that do not possess the desired item attributes 118 of condensed, low fat, and no MSG in canned soup product set 116. For example, mapping data structure 114 accesses product database 56, maintained by consumer service provider 52, through web-based intelligent personal agent 54. Mapping data structure 114 compares item attributes 118 of canned soup 112 to attributes of potentially matching products 18 to determine whether a given product will be placed in product set 116 corresponding to item canned soup. Mapping data structure 114 retrieves product information for all varieties of canned soup 112. Mapping data structure 114 compares product information for all varieties of canned soup 112 with the desired item attributes to determine which varieties of canned soup are interchangeable with canned soup 112. Mapping data structure 114 retrieves product attributes stored in product database 56 regarding house brand minestrone soup 18. Mapping data structure 114 compares the product attributes stored in product database 56 regarding house brand minestrone soup 18 to desired item attributes 118. Mapping data structure 114 determines that house brand minestrone soup 18 possesses the desired item attributes 118 of condensed, low fat, and no MSG and places house brand minestrone soup in canned soup product set 116. Mapping data structure 114 retrieves product attributes stored in product database 56 regarding house brand chicken noodle soup 18. Mapping data structure 114 compares the product attributes stored in product database 56 regarding house brand chicken noodle soup 18 to desired item attributes 118. Mapping data structure 114 determines that house brand chicken noodle soup 18 possesses the desired item attributes 118 of condensed, low fat, and no MSG and places house brand chicken noodle soup in canned soup product set 116. Mapping data structure 114 retrieves product attributes stored in product database 56 regarding house brand tomato soup 18. Mapping data structure 114 compares the product attributes stored in product database 56 regarding house brand tomato soup 18 to desired item attributes 118. Mapping data structure 114 determines that house brand tomato soup 18 possesses the desired item attributes 118 of condensed, low fat, and no MSG and places house brand tomato soup in canned soup product set 116. Similarly, mapping data structure 114 determines that house brand split pea soup 18 possesses the desired item attributes 118 of condensed, low fat, and no MSG and places house brand split pea soup in canned soup product set 116. Mapping data structure 114 determines that name brand minestrone soup 18 possesses the desired item attributes 118 of condensed, low fat, and no MSG and places name brand minestrone soup in canned soup product set 116. Similarly, mapping data structure 114 determines that name brand chicken noodle soup 18 possesses the desired item attributes 118 of condensed, low fat, and no MSG and places name brand chicken noodle soup in canned soup product set 116. Mapping data structure 114 determines that name brand tomato soup 18 possesses the desired item attributes 118 of condensed, low fat, and no MSG and places name brand tomato soup in canned soup product set 116. Mapping data structure 114 determines that name brand split pea soup 18 possesses the desired item attributes 118 of condensed, low fat, and no MSG and places name brand split pea soup in canned soup product set 116.

In contrast, mapping data structure 114 retrieves product attributes stored in product database 56 regarding house brand baked potato soup 18. Mapping data structure 114 compares the product attributes stored in product database 56 regarding house brand baked potato soup 18 to desired item attributes 118. Mapping data structure 114 determines that house brand baked potato soup 18 does not possess the desired item attribute 118 of low fat and does not place house brand baked potato soup in canned soup product set 116. Mapping data structure 114 retrieves product attributes stored in product database 56 regarding name brand lentil soup 18. Mapping data structure 114 compares the product attributes stored in product database 56 regarding name brand lentil soup 18 to desired item attributes 118. Mapping data structure 114 determines that name brand lentil soup 18 does not possess the desired item attribute 118 of condensed and does not place name brand lentil soup in canned soup product set 116. Similarly, mapping data structure 114 determines that name brand egg drop soup 18 does not possess the desired item attribute 118 of no MSG and does not place name brand egg drop soup in canned soup product set 116. Mapping data structure 114 continues comparing product attributes against desired item attributes 118 for all varieties of canned soup 18. Mapping data structure 114 places all varieties of canned soup 18 that possess the desired item attributes 118 of condensed, low fat, and no MSG in canned soup product set 116. Mapping data structure 114 does not place varieties of canned soup 18 that do not possess the desired item attributes 118 of condensed, low fat, and no MSG in canned soup product set 116.

FIG. 11b shows mapping data structure 114 determining a specific set of products, canned soup product set 116, interchangeable for canned soup 112. Canned soup product set 116 contains products 18 that function as substitutes, alternatives, replacements, choices, or options for canned soup 112. Products 18 in product set 116 are interchangeable for item 112. Mapping data structure 114 links product set 116 to item 122. Mapping data structure 114 determines products 18 in canned soup product set 116 based on item attributes 118 and product information retrieved from product database 56, maintained by consumer service provider 52. Canned soup product set 116 contains house brand minestrone soup 18, house brand chicken noodle soup, house brand tomato soup, house brand split pea soup, name brand minestrone soup, name brand chicken noodle soup, name brand tomato soup, and name brand split pea soup.

Most lists 73 have more than one item 112. Mapping data structure 114 generates product sets 116 corresponding to each item 112 on list 73 using product attributes retrieved from product database 56 maintained by consumer service provider 52. Each product 18 in product set 116 functions as a substitute, alternative, replacement, choice, or option for a corresponding item 112 from list 73. Products 18 in product set 116 are interchangeable for item 112. Mapping data structure 114 links product set 116 to item 112.

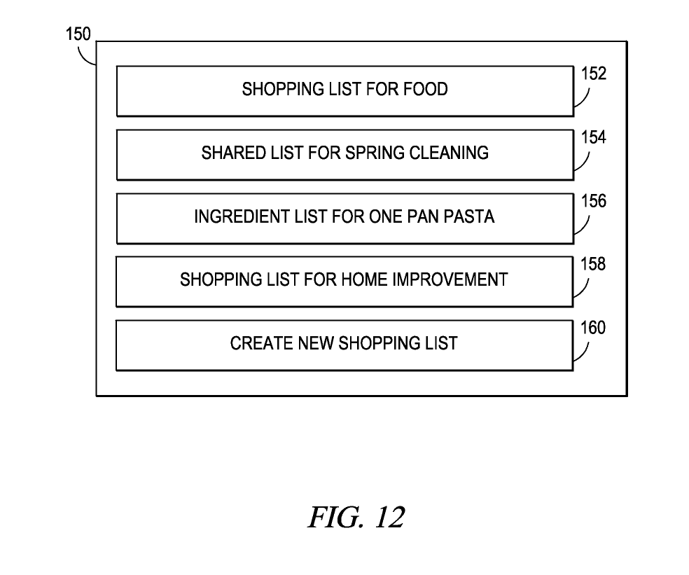

Returning to homepage 120, shown in FIG. 10, contributor 104 is building list 108 of spring-cleaning items 112 to share. Contributor 104 selects create shopping list button 128 to bring up shopping list webpage 150, shown in FIG. 12. Shopping list webpage 150 allows contributor 104 to build shared list 108 of renewable earth friendly spring-cleaning supplies. Consumers 42-44 create new shopping lists 73 and update existing shopping lists 73 by entering, modifying, or deleting products 18 through one or more webpages, or by mobile app. Consumer service provider segregates shopping lists 73 by type of items 112, e.g., different shopping lists 73 for grocery items, household items, apparel, books, and auto parts. Shopping lists 73 are also segregated by household member, e.g., different shopping lists 73 for each spouse, child, or other member of the household. Master shopping list 73 is created when all items 112 needed by the entire household are aggregated into a single list. Shopping list 73 is any logical grouping of items 112 necessary or desirable to accomplish an intended purpose. In webpage 150 of FIG. 12, intelligent personal agent 54 presents link 152 to existing shopping list 73 for grocery items, link 154 to existing shared list 108 for spring-cleaning supplies, link 156 to existing ingredient list 73 for One Pan Pasta, and link 158 to existing shopping list 73 for home improvement items, as well as button 160 to create new shopping list 73. Contributor 104 selects a link to add, delete, modify, or share shopping list 73. Contributor 104 selects button 160 to create new list 73.

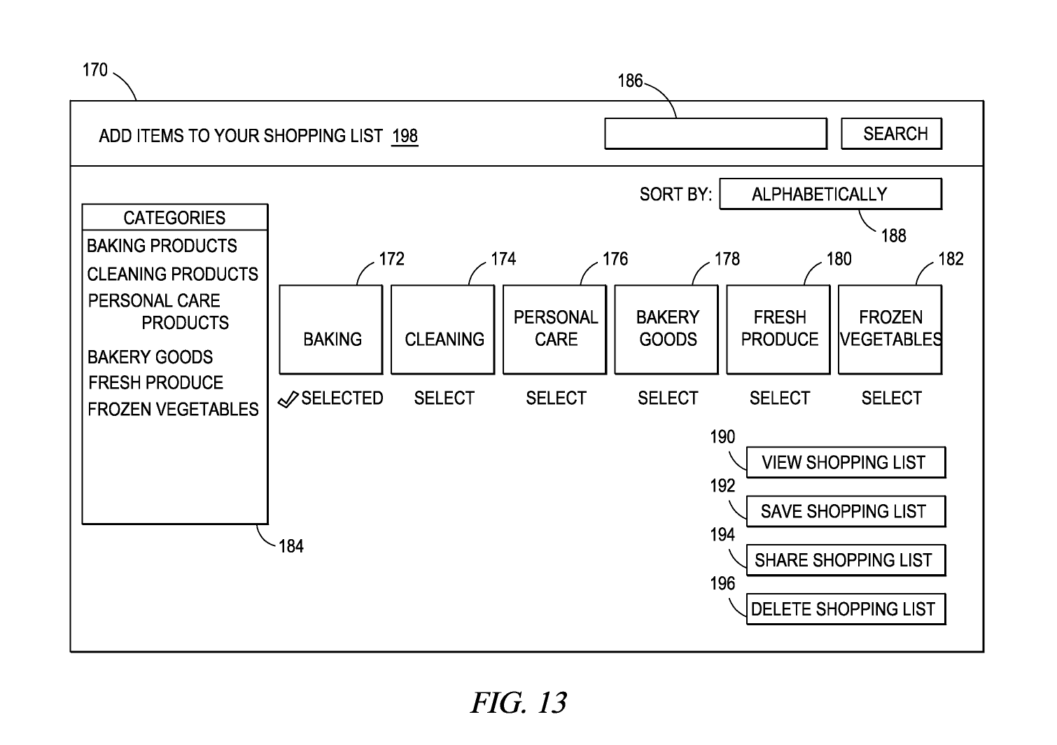

As an illustration of links 152-160, FIG. 13 shows webpage 170 provided for building shopping list 198. Webpage 170 presents categories of grocery items. A category is presented for each type of grocery item. For example, block 172 with corresponding select button is presented for baking products or baking product family (BP), block 174 with corresponding select button is presented for cleaning supplies family (CS), block 176 with corresponding select button is presented for personal care or personal care family (PC), block 178 with corresponding select button is presented for bakery goods or bakery goods family (BG), block 180 with corresponding select button is presented for fresh produce or fresh produce family (FP), and block 182 with corresponding select button is presented for frozen vegetables or frozen vegetables family (FV). A list of categories of grocery items is also presented in block 184. Block 186 with adjacent search button enables contributor 104 to search for other categories or specific grocery items. Button 188 enables contributor 104 to sort the categories of grocery by cost, frequency of purchase, alphabetically, or other convenient attribute. Button 190 enables contributor 104 to view shopping list 198. Button 192 enables contributor 104 to save shopping list 198. Consumer service provider 52 saves shopping list 198 for contributor 104 in product database 56. Button 194 enables contributor 104 to share shopping list 198. Button 196 enables contributor 104 to delete shopping list 198.

Contributor 104 builds shared list 108 by adding items 112 to the list. Contributor 104 selects button 172 to select the baking product family. Contributor 104 adds vinegar 112 to list 198. Contributor 104 selects item attribute 118 of distilled white vinegar to add to vinegar 112. Contributor 104 adds baking soda 112 to list 198. Contributor 104 selects item attribute 118 of 16 ounces to add to baking soda 112. Contributor 104 adds salt 112 to list 198. Contributor 104 does not add any item attributes 118 to salt 112. Contributor 104 adds lavender oil 112 to shopping list 198 directly by typing lavender oil into block 186. Contributor 104 does not add any item attributes 118 to lavender oil 112. Contributor 104 saves shopping list 198 by selecting save shopping list button 192. Consumer service provider 52 stores and maintains shopping list 198 in product database 56. Contributor 104 shares shopping list 198 by selecting share shopping list button 194.

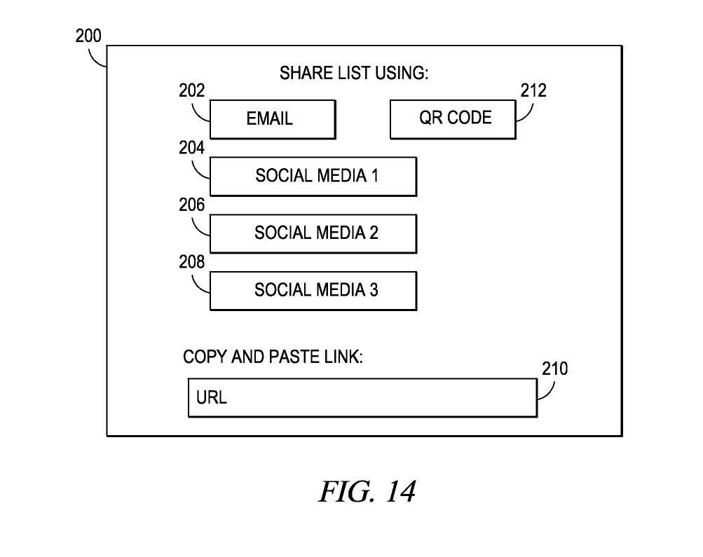

Selecting share shopping list button 194 brings up share list webpage 200 shown in FIG. 14. Consumer service provider 52 enables nationwide list 73 and recipe 74 sharing. Traditionally, shopping is a regional or local activity. Specific products 18 that are available in one community may not be available nationwide. Consumer service provider 52 solves the problem by sharing lists 108 comprised of general items of interest 112. Mapping data structure 114 generates product sets 116 corresponding to each item 112 on shared list 108. Intelligent personal agent 54 identifies products 18 from product set 116 available at retailers 46-50, local to consumers 42-44. Consumers 42-44 are able to find products 18 available at retailers 46-50, local to the consumers, interchangeable with items 112 from shared lists 108, using intelligent personal agent 54. Consumers 42-44 and contributor 104 may share lists 108 with friends and family across the country confident in the knowledge that intelligent personal agent 54 will locate an equivalent product 18 available at retailers 46-50, local to friends and family for each item 112 on the list.

Consumers 42-44 and contributor 104 share lists 108 in a variety of ways. Contributor 104 generates emails by selecting email button 202. Consumers 42-44 post lists 108 on social media websites by selecting social media buttons 204-208. Additionally, contributor 104 accesses URL links 106 to lists 108 in URL block 210. Contributor 104 generates Quick Response (QR) codes by selecting QR code button 212. For example, contributor 104 selects URL block 210 to copy link 106 to shared list 108 of renewable earth friendly spring-cleaning supplies. Contributor 104 posts link 106 on the non-profit group's website and encourages readers to buy only products 18 on shared list 108 rather than more environmentally harmful products available. Contributor 104 writes an article to accompany link 106 to shared list 108 of earth friendly spring-cleaning items 112. Contributor 104 posts the article with link 106.

Contributor 104 may also post a link to the non-profit group's story about environmentally friendly spring-cleaning on social media websites. Additionally, the environmental website has dedicated readers and the readers post links to the story including link 106 on social media websites. Consumer 42 reads the article and decides to use only items 112 on shared list 108 for cleaning. Consumer 42 follows link 106 to website 100. Consumer 42 may need to create an account to access homepage 120. Consumer 42 wants to buy products 18 corresponding to the items 112 on shared list 108. Items 112 on shared list 108 are general items of interest. A general items of interest 112, i.e., salt, is a non-specific generalization of a desired product. Consumers 42-44 buy specific products 18, i.e., Morton® brand 26-ounce iodized salt, from retailers 46-50. Consumer service provider 52 assists consumer 42 by replacing item 112 with specific product 18. First mapping data structure 114 generates product sets 116 corresponding to items 112. Mapping data structure 114 maps white vinegar product set 116 to white vinegar 112, baking soda product set 116 to baking soda 112, salt product set 116 to salt 112, and lavender oil product set 116 to lavender oil 112. Later, intelligent personal agent 54 selects one optimal product 18 from each product set 116 that maximizes the satisfaction of consumer 42 and places that product on optimized shopping list 110, as explained later.

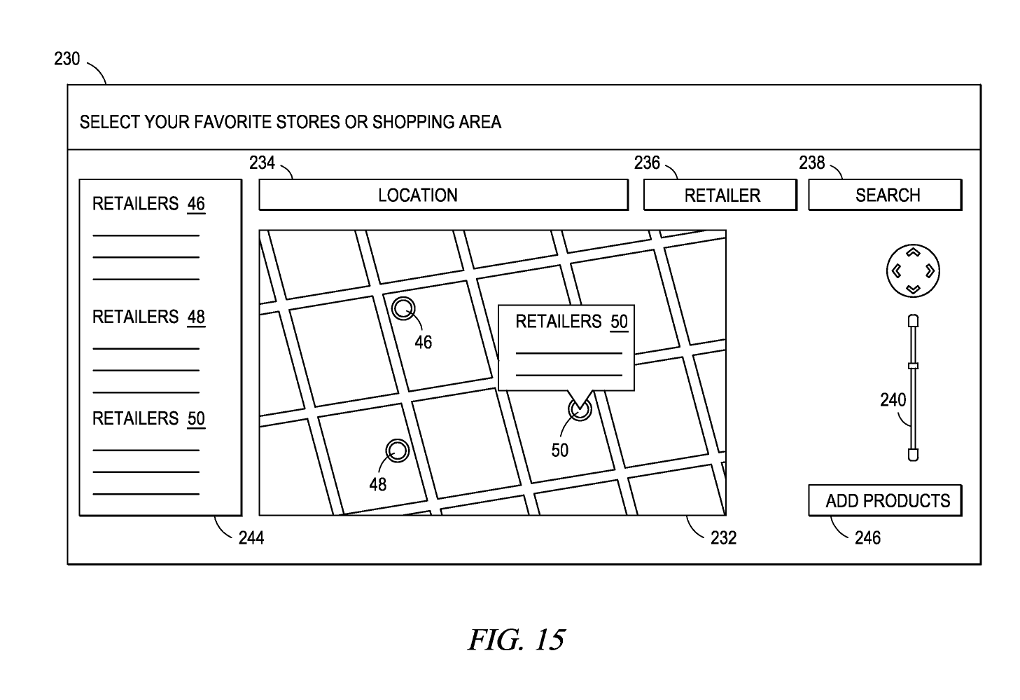

Additionally, consumer service provider 52 must find out which retailers 46-50 are acceptable to consumer 42. Consumer 42 logs on to website 100 and navigates to homepage 120 to access shopping areas button 126. Under define preferred retailers and shopping areas button 126, intelligent personal agent 54 presents shopping area webpage 230 with local map 232, as shown in FIG. 15. The scale of map 232 is adjusted with scale bar 240. A location is entered in block 234, and retailer name, retailer type, or retailer chain is entered in block 236. Product database 56 contains the name, type, description, and location of retailers nationwide. Consumer 42 selects search button 238 to search product database 56 for local retailers 46-50 according to the location and retailer search pattern in blocks 234-236. The local retailers 46-50 matching the search criteria are displayed on map 232. Consumer 42 searches for grocery retailers and selects retailers 46-50 that he or she would be willing to patronize by individually clicking on the retailer location identifiers 46-50 on map 232. An image, address, phone number, retailer type, retailer website, operating hours, description, and consumer rating, and comments of selected retailers 46-50 are displayed in block 244. Consumer 42 additionally identifies online retailers 46-50 that he or she would be willing to patronize. Intelligent personal agent 54 considers product availability at local retailers 46-50 when selecting product 18 from each product set 116.

Once the preferred retailers 46-50 are defined, consumer 42 selects add products button 246 to add items 112 from shared list 108 to shopping list 198. Add products button 246 creates shopping list 198 of items 112. Mapping data structure 114 determines product sets 116 for each item 112 on shopping list 198. Because consumer 42 clicked on link 106 to access website 100, intelligent personal agent 54 will prepopulate shopping list 198 with items 112 on shared list 108 for earth friendly spring-cleaning items, i.e., white vinegar 112, baking soda, salt, and lavender oil. Consumer 42 does not need to enter items 112 from list 108 for earth friendly spring-cleaning, i.e., white vinegar, baking soda, salt, and lavender oil, onto shopping list 198. Intelligent personal agent 54 places white vinegar 112, baking soda, salt, and lavender oil on shopping list 198 before presenting the shopping list to consumer 42. Mapping data structure 114 generates a corresponding product set 116 for each item 112 on shopping list 198.

Consumer 42 intends to purchase groceries in addition to the earth friendly spring-cleaning supplies. Consumer 42 adds additional items 112 to shopping list 198 using build shopping list webpage 170 as described above. For example, consumer 42 adds 100% whole wheat bread 112 from the bakery goods family and frozen corn from the frozen vegetable family. Once consumer 42 has built combined shopping list 198 including items 112 from shared list 108, i.e., white vinegar, baking soda, salt, and lavender oil, consumer 42 assigns weights to the item attributes 118 items 112 on combined list 198.

Consumer 42 assigns weights to item attributes 118 of items 112 on list 198 using product family buttons 172-182 from build shopping list webpage 170 shown in FIG. 13. Each item 112 on list 198 has item attributes 118. Consumer 42 assigns a weight to each item attribute 118 based on personal consumer preference. The item attribute 118 weighting values reflect the level of importance or preference that consumer 42 bestows on each item attribute 118. The available item attributes 118 include product-specific attributes, diet/health/nutrient related product attributes, lifestyle related product attributes, environment related product attributes, allergen related product attributes, and social/society related product attributes. The item attributes 118 also include brand, ingredients, grade, size, price, freshness, retailer preference, warranty, and the like. Intelligent personal agent 54 considers consumer-weighting factors for item attributes 118 when selecting product 18 from each product set 116.

Consumers 42-44 set the weighting factors for the item attributes 118 by product families. Consumers 42-44 select the desired product family button 172-182 from FIG. 13, for example, baking product family button 172. Once the item attributes 118 and weighting factors for all baking products are defined by consumer preference, consumer 42 makes selections for the next product category; for example, the cleaning product family. In another embodiment, consumer 42 records item attributes 118 and weighting factors using a mobile application or app. Consumer service provider 52 provides intelligent personal agent 54 to determine which product 18 from each product set 116 is best for consumer 42 based on weighted item attributes 118.

Given the consumer-generated initial list of items 112, intelligent personal agent 54 executes a comparative shopping service to optimize shopping list 198 and determines which products 18 should be purchased from which retailers 46-50 on which day to maximize the value to consumer 42 as defined by the consumer profile and weighted item attributes 118. Intelligent personal agent 54 selects one product 18 from each product set 116 on shopping list 198 to maximize the value to consumer 42. Alternatively, intelligent personal agent 54 selects one or more products 18 that meet or exceed a consumer satisfaction threshold as defined by shopping list 198 and consumer-defined item attribute 118 weights from product set 116 and places the selected product or products on optimized shopping list 110. Intelligent personal agent 54 considers consumer-weighting factors for item attributes 118 and specific consumer requirements when selecting product 18 from each product set 116. Intelligent personal agent 54 optimizes list 198 by evaluating product set 116 corresponding to each item 112 on shopping list 198 from webpage 170 and reviewing retailer product information in product database 56 to determine how to best align each item 112 to be purchased with the available products 18 from retailers 46-50. For example, consumer 42 wants to purchase baking products 112 and has provided shopping list 198 with preference levels for weighted item attributes 118 for baking soda and other baking products 112 that are important to his or her purchasing decision. Product database 56 contains baking product descriptions, baking item attributes 118, and pricing for each retailer 46-50. Intelligent personal agent 54 reviews the item attributes 118 of baking products and product families offered by each retailer 46-50, as stored in product database 56. The more specific the consumer-defined item attributes 118, the narrower the search field but more likely consumer 42 will get the preferred product 18 or product family. The less specific the consumer-defined item attributes 118, the wider the search field and more likely consumer 42 will get the most choices and best pricing.

Intelligent personal agent 54 compares the item attributes 118 of each baking product 18 and product family for retailers 46-50 in product database 56 to the consumer-defined weighted item attributes 118 in shopping list 198. For example, available baking products and product families from retailer 46 are retrieved and compared to the weighted item attributes 118 of consumer 42. Likewise, available baking products and product families from retailer 48 are retrieved and compared to the weighted item attributes 118 of consumer 42, and available baking products and product families from retailer 50 are retrieved and compared to the weighted item attributes 118 of consumer 42. Intelligent personal agent 54 selects product 18 that meets or exceeds a consumer satisfaction threshold as defined by shopping list 198 based on the consumer-defined item attribute 118 weights from product set 116 and places the selected product on optimized shopping list 110. Alternatively, intelligent personal agent 54 selects products 18 and retailers 46-50 that maximize a value to consumer 42 as defined by shopping list 198 based on the consumer-defined item attribute 118 weights from each product set 116 and places the selected products on optimized shopping list 110. Intelligent personal agent 54 considers consumer-weighting factors for item attributes 118 and specific consumer requirements when selecting product 18 from each product set 116. Intelligent personal agent 54 considers available discounts when selecting product 18. Intelligent personal agent 54 selects product 18 to generate a purchase of the product by consumer 42. Intelligent personal agent 54 influences the purchasing decisions of consumer 42.

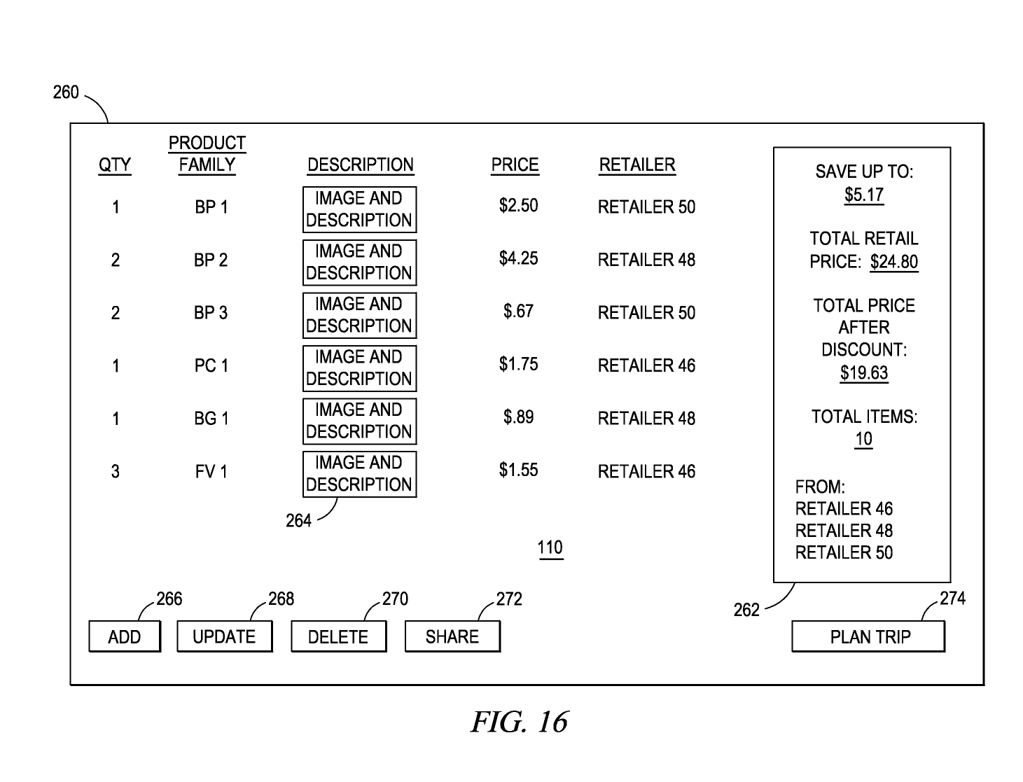

Consumer 42 views optimized shopping list 110 by clicking on view shopping list button 190 in FIG. 13. Optimized shopping list 110 is presented to consumer 42 on optimized shopping list webpage 260 shown in FIG. 16. Optimized shopping list 110 includes products 18 from product sets 116 corresponding to items 112 from shared list 108. Optimized shopping list 110 includes the selected products 18 for consumer 42 chosen by intelligent personal agent 54 based on the consumer item attribute 118 weighting factors and product information from retailers 46-50 in product database 56 and the specific requirements of consumer 42. The highest ranked product 18 for items 112 in each grocery category is displayed with quantity, product name, description field, price, and retailer 46.

A list of retailers 46-50 to be patronized is shown in block 262, based on products 18 contained in optimized shopping list 110. Images and descriptions are shown in block 264. Optimized shopping list 110 is organized by cost, frequency of purchase, aisle, or location within the establishment of retailer 46, alphabetically, or other convenient attribute. Consumer 42 modifies optimized shopping list 110, as well as the consumer item attribute 118 weighting factors, with add button 266, update button 268, or delete button 270. Consumer 42 shares optimized shopping list 110 with share button 272. Consumer 42 accesses trip planning with plan trip button 274.

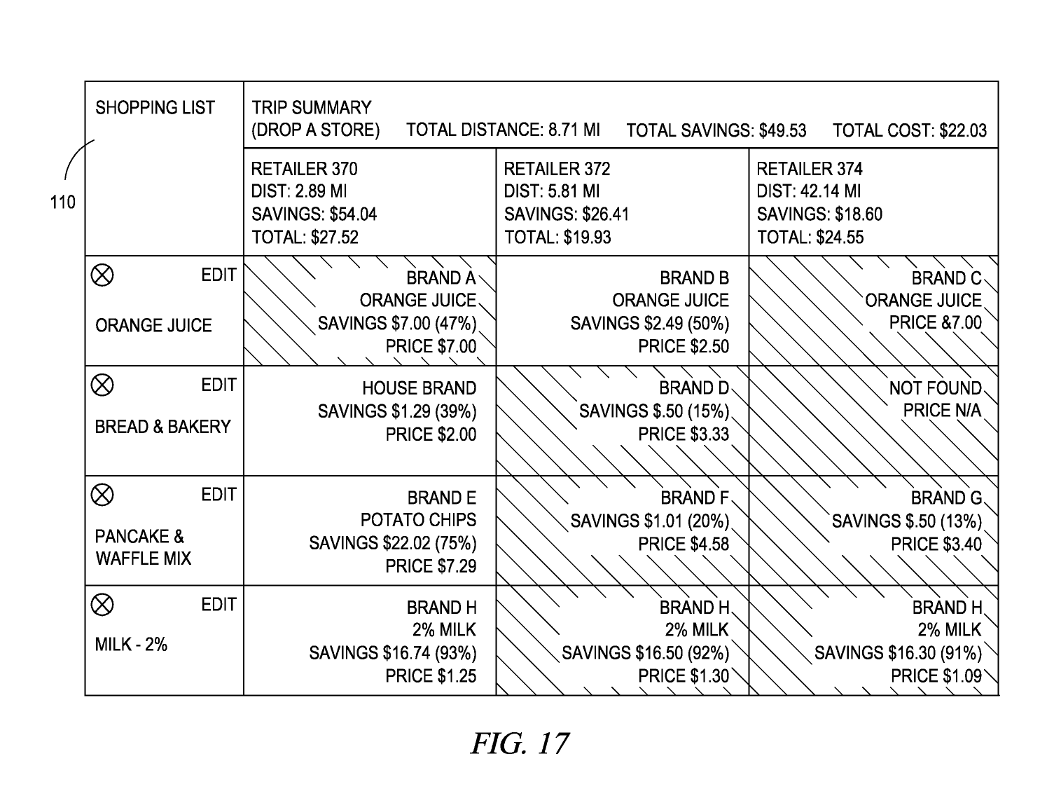

In another embodiment, multiple brands and/or retailers 46-50 for a single product 18 are placed on optimized shopping list 110. FIG. 17 shows one example of intelligent personal agent 54 placing the three highest ranked brands and/or retailers 46-50 on optimized shopping list 110, and allowing consumer 42 to make the final selection and purchasing decision.

Once optimized shopping list 110 has been generated, consumer 42 travels to local retailers 46-50 and accesses optimized shopping list 110. Consumer 42 may access optimized shopping list 110 on his or her cell phone 66. Alternatively, consumer 42 may print out a copy of optimized shopping list 110 from webpage 260 and bring the print out to local retailers 46-50. Consumer 42 purchases the goods, including products 18 from product sets 116 interchangeable with items 112 from shared list 108 of renewable earth friendly spring-cleaning supplies, i.e., white vinegar, baking soda, salt, and lavender oil. However, if product 18, house brand 32-ounce distilled white vinegar for example, is unfamiliar to consumer 42, intelligent personal agent 54 assists consumer 42 in finding the specific product aisle and shelf location of the product at retailer 46. Consumer service provider 52 controls an activity within commerce system 40 when consumer 42 purchases the goods based on the recommendations of consumer service provider 52 and intelligent personal agent 54.

Cell phones 66 contain a global positioning system (GPS) device to determine the location of consumer 42 while in the premises of retailer 46. Knowledge of the present location of consumer 42 provides a number of advantages. Intelligent personal agent 54 gives directions to consumer 42 of the shelf location of any product 18 on optimized shopping list 110. With RF ID tag attached to products 18, cell phone 66 displays directional information such as text or arrows to guide consumer 42 to the product location. Many retailers 46-50 offer in-store locator systems in communication with cell phone 66 to assist with finding specific products 18. Consumers 42-44 looking for unfamiliar products 18 associated with new recipes 74 utilize cell phone 66 technology for assistance.

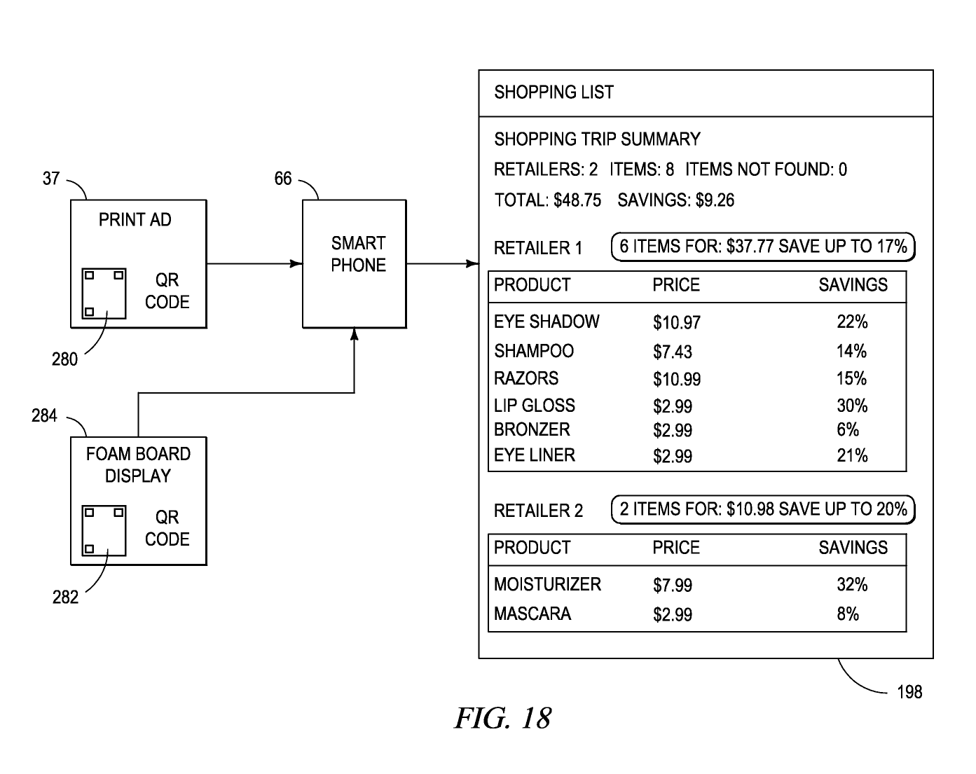

FIG. 18 shows offline to online wireless list sharing using QR codes 280-282. While at the premises of retailer 46, looking at products 18, consumers 42-44 scan QR codes 280-282 on display. QR codes 280-282 are generated by consumer service provider 52 when QR code button 212 from share list webpage 200 shown in FIG. 14 is selected. Manufacturer 22 runs print add 37 with QR code 280. Shared list 108 of selected products 18 of manufacturer 22 is embedded in QR code 280. Distributor 26 places foam board display 284 featuring QR code 282 on the premises of local retailer 46. Consumer 42 accesses QR codes 280-282 with cell phone 66. Cell phone 66 runs an app that translates data embedded in QR codes 280-282 into shared list 108. Consumer 42 previously defined acceptable local retailers 46-50 as described above. Intelligent personal agent 54 locates products 18 interchangeable with items 112 from shared list 108 available at local retailers 46-50 and presents optimized shopping list 110 to consumer 42 on cell phone 66.

Consumers 42-44 also use consumer service provider 52 and intelligent personal agent 54 to assist with the menu planning process. Consumers 42-44 purchase grocery products 18 for the purpose of preparing recipes 74 and serving meals. Consumer service provider 52 maintains recipe database 58. Recipe database 58 stores information about each recipe such as a title, brief description, allergy information, nutritional information, number of servings, serving size, consumer rating, ingredient list, photograph, cooking instructions, community rating, notes, contributor, and other information. Consumer service provider 52 maintains recipe database 58. Intelligent personal agent 54 suggests recipes 74 for consumers 42-44 based on current or past items of interest 112 to consumers 42-44. Each recipe 74 includes list 73 of ingredients necessary to prepare the recipe.

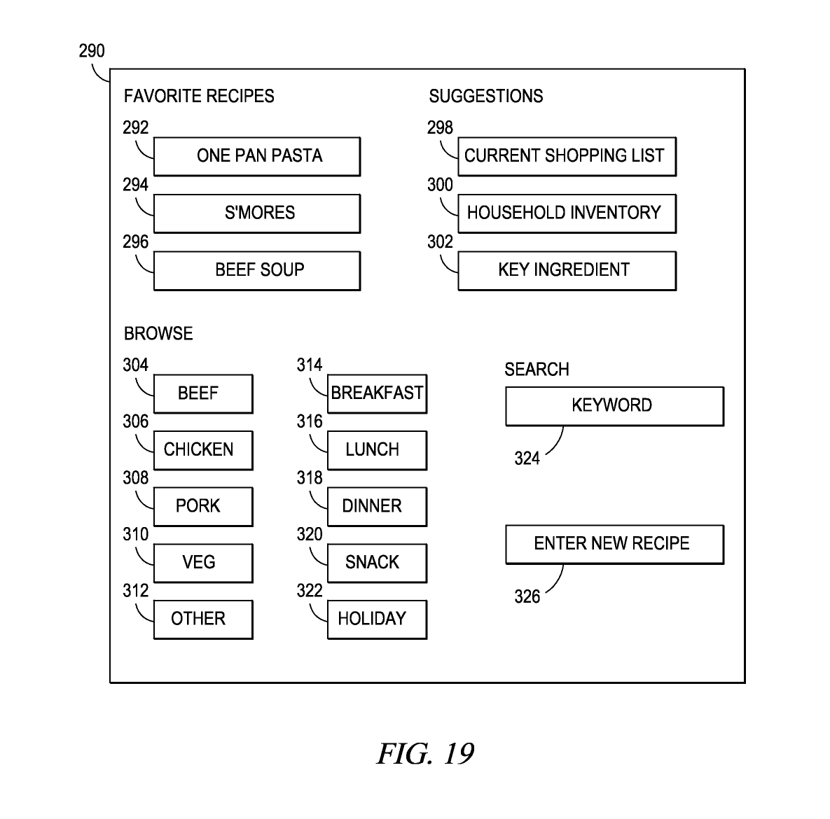

Consumer service provider 52 makes it easy for consumers 42-44 to browse and share recipes 292-296. FIG. 19 shows an example of recipe webpage 290. Recipe webpage 290 is accessed from homepage 120 by selecting recipe webpage button 134. Recipes 292-296 are contributed to recipe database 58 by consumers 42-44, professional chefs, home cooks, retailers 46-50, manufacturers 22, distributors 26, staff of consumer service provider 52, or other sources. Intelligent personal agent 54 accesses recipe database 58 to search for recipes 292-296 of interest to consumer 42 based on the criteria specified by the consumer and the recipe information stored in recipe database 58. Once recipe 292 is entered into recipe database 58, consumer service provider 52 allows recipe 292 to be widely shared online, by generating URL link 106 to recipe 292, offline, through QR codes 280-282, and in emails. For example, consumer 42 wants to share recipe 292 for S'mores. Consumer 42 logs into to the website 100 as described above and navigates to homepage 120. Consumer 42 calls up recipe webpage 290 from homepage 120 by selecting recipe webpage button 134.

FIG. 19 shows an example of main recipe webpage 290. Consumer 42 adds new recipe 292 to recipe database 58 by selecting enter new recipe button 326 on recipe webpage 290. Selecting enter new recipe button 326 brings up individual recipe webpage 340.

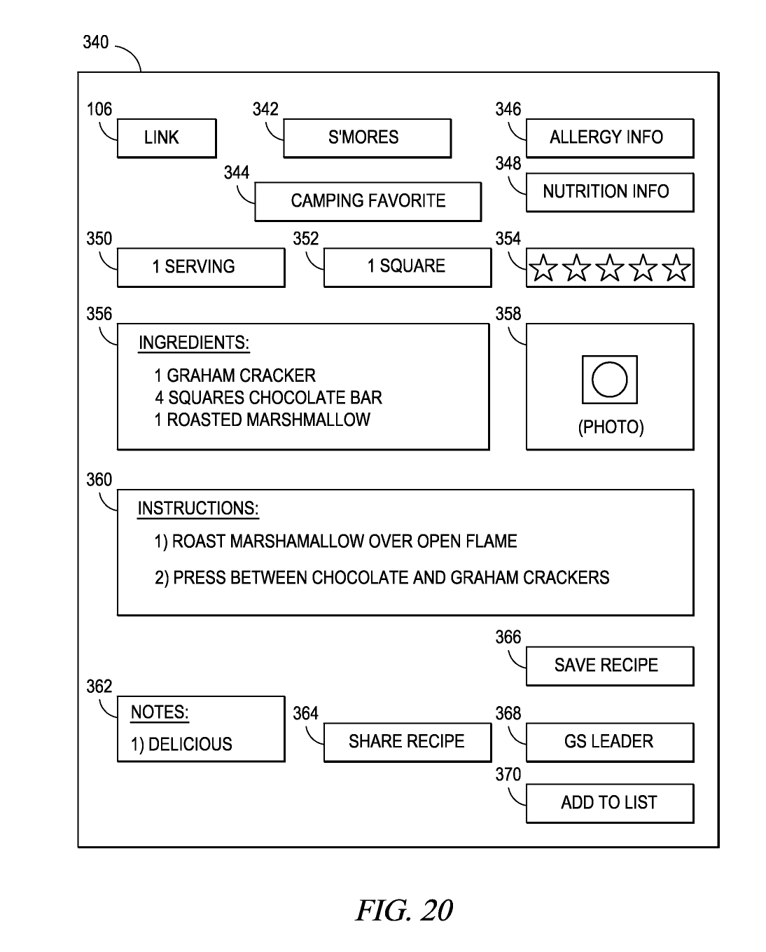

FIG. 20 shows an example of individual recipe webpage 340. Individual recipe webpage 340 contains title block 342, brief description block 344, allergy information block 346, nutritional information block 348, number of servings block 350, serving size block 352, consumer-rating block 354, ingredient list block 356, photograph block 358, cooking instructions block 360, community-rating block 361, notes block 362, share recipe button 364, save recipe button 366, contributor block 368, and add to list button 370. Consumer 42, who wants to share recipe 292 for S'mores, enters the recipe into recipe database 58 from individual recipe webpage 340. Consumer 42 selects title block 342 to enter the title for recipe 292 and enters S'mores into the title block. Consumer 42 selects brief description block 344 to enter the brief description for recipe 292 and enters camping favorite into the brief description block. Consumer 42 selects contributor block 368 to enter the contributor for recipe 292 and enters GSLeader into the contributor block. Consumer 42 selects serving size block 352 to enter the serving size for recipe 292 and enters one square into the serving size block. Consumer 42 selects number of servings block 350 to enter the number of servings for recipe 292 and enters 1 serving into the number of servings block. Consumer 42 selects cooking instructions block 360 to enter the cooking instructions for recipe 292 and enters ‘roast marshmallows over open flame and press between chocolate and graham crackers’ into the cooking instructions block.

Consumer 42 selects consumer-rating block 354 to enter the consumer rating for recipe 292 and enters five stars into the consumer-rating block. Intelligent personal agent 54 determines community-rating 361 based on the average consumer rating 354 for each recipe 292-296 in recipe database 58. If consumer 42 has not rated recipe 292, community-rating block 361 is shown on individual recipe webpage 340. If consumer 42 has rated recipe 292, then consumer-rating block 354 is displayed on individual recipe webpage 340. Consumer 42 selects note block 362 to enter the note for recipe 292 and enters delicious into the note block. Consumer 42 selects ingredient list block 356 to enter ingredient list 356 for recipe 292, as explained below. Consumer 42 selects save recipe button 366 to save recipe 292. Consumer service provider 52 saves recipe 292 in recipe database 58. Recipe database 58 stores recipe information such that recipes 292-296 are searchable based on key ingredients, keywords, allergy information, categories, meals, and other criteria. Consumer 42 selects add to list button 370 to add ingredients 402-406 from recipe 292 to shopping list 198. Consumer 42 selects share recipe button 364 to share recipe 292.

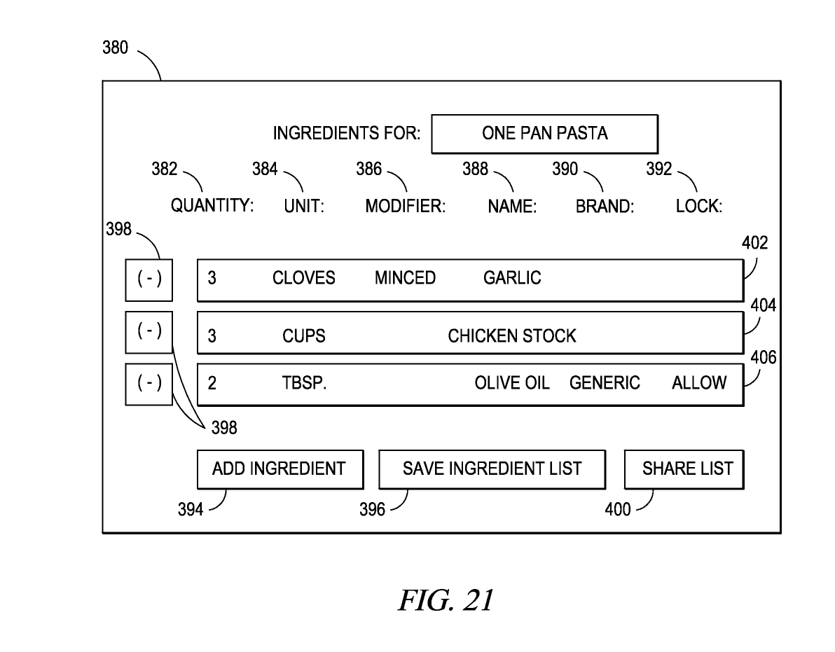

Selecting ingredient list block 356 from individual recipe webpage 340 brings up ingredient list webpage 380. FIG. 21 shows an example of ingredient list webpage 380. Each ingredient 402-406 has name 388, modifier 386, quantity 382, and unit 384. In one embodiment, each ingredient 402-406 also has brand identifier 390 and brand lock 392. Ingredient information for each recipe 292-296 is stored in recipe database 58 maintained by consumer service provider 52. To enter list 73 of ingredients 402-406 in recipe 292 for S'mores, consumer 42 navigates to ingredient list webpage 380 from individual recipe webpage 340 for S'mores. Consumer 42 selects add ingredient button 394 from ingredient list webpage 380. Ingredient block 402 for entry of ingredient information is provided.

For example, ingredient 402 in S'mores is graham crackers. Ingredient graham cracker 402 has name 388 graham cracker and quantity 382 of 1. Consumer 42 enters the graham cracker information in ingredient block 402 and selects add ingredient button 394 to bring up new ingredient block 404. Ingredient chocolate bar 404, also in recipe 292 for S'mores, has name 388 chocolate bar, quantity 382 of 4, and unit 384 squares. Consumer 42 enters the chocolate bar information in ingredient block 404 and selects add ingredient button 394 to bring up new ingredient block 406. Ingredient marshmallow 406 has name 388 marshmallow, quantity 382 of 1, unit 384 of large, and modifier 386 roasted. Consumer 42 enters the marshmallow information in ingredient block 406. When all ingredients 402-406 for recipe 292 are correct, consumer 42 selects save ingredient list button 396 to save ingredient list 356. Recipe database 58 associates ingredient list 356 with recipe 292. Consumer 42 views ingredient list 356 on computer screen 88, tablet 70, or cell phone 66.

Once consumer 42 has saved recipe 292 to recipe database 58, it is available to other consumers 14, 34, and 44 by accessing recipe webpage 290, shown in FIG. 19. Recipe database 58 stores information about each recipe 292-296 such as title 342, brief description 344, allergy information 346, nutritional information 348, number of servings 350, serving size 352, consumer rating 354, ingredient list 356, photograph 358, cooking instructions 360, community rating 361, notes 362, and contributor 368. Recipe database 58 stores recipe information such that recipes 292-296 are searchable based on key ingredients 402-406, keywords 342-344, allergy information 346, categories 304-312, meals 314-322, and other criteria. Intelligent personal agent 54 accesses recipe database 58 to search for recipes 292-296 of interest to consumer 44 based on the criteria specified by consumer 42 and the recipe information stored in recipe database 58. Consumer service provider 52 maintains recipe database 58.

Recipe webpage 290, shown in FIG. 19, is used by consumer 44 to search recipe database 58 using intelligent personal agent 54. Consumer 44 may use keyword searching using keyword block 324 or category browsing using category blocks 304-322. Category block 304 allows consumer 44 to browse recipes featuring beef. Category block 306 allows consumer 44 to browse recipes featuring chicken. Category block 308 allows consumer 44 to browse recipes featuring pork. Category block 310 allows consumer 44 to browse vegetarian recipes. Category block 312 allows consumer 44 to browse miscellaneous recipes. Category block 314 allows consumer 44 to browse breakfast recipes. Category block 316 allows consumer 44 to browse lunch recipes. Category block 318 allows consumer 44 to browse dinner recipes. Category block 320 allows consumer 44 to browse snack recipes. Category block 322 allows consumer 44 to browse holiday recipes. Additionally, intelligent personal agent 54 suggests recipes for consumer 44 as described below.

Consumer 44 may find the recipe for S'mores contributed to recipe database 58 by consumer 42 in a number of ways. Consumer 44 is looking for a sweet treat using marshmallows. Consumer 44 searches recipe database 58 and finds recipe 292 for S'mores contributed by consumer 42 by selecting key ingredient button 302 and entering marshmallow. Alternatively, consumer 44 is planning a camping trip and looking for some traditional favorite camping recipes. Consumer 44 searches recipe database 58 and finds recipe 292 for S'mores by entering camping in keyword block 324. Alternatively, consumer 44 is specifically looking for a recipe for S'mores. Consumer 44 searches recipe database 58 and finds recipe 292 for S'mores by entering S'mores in keyword block 324. Consumer 44 reads recipe 292 for S'mores and decides to make the recipe.

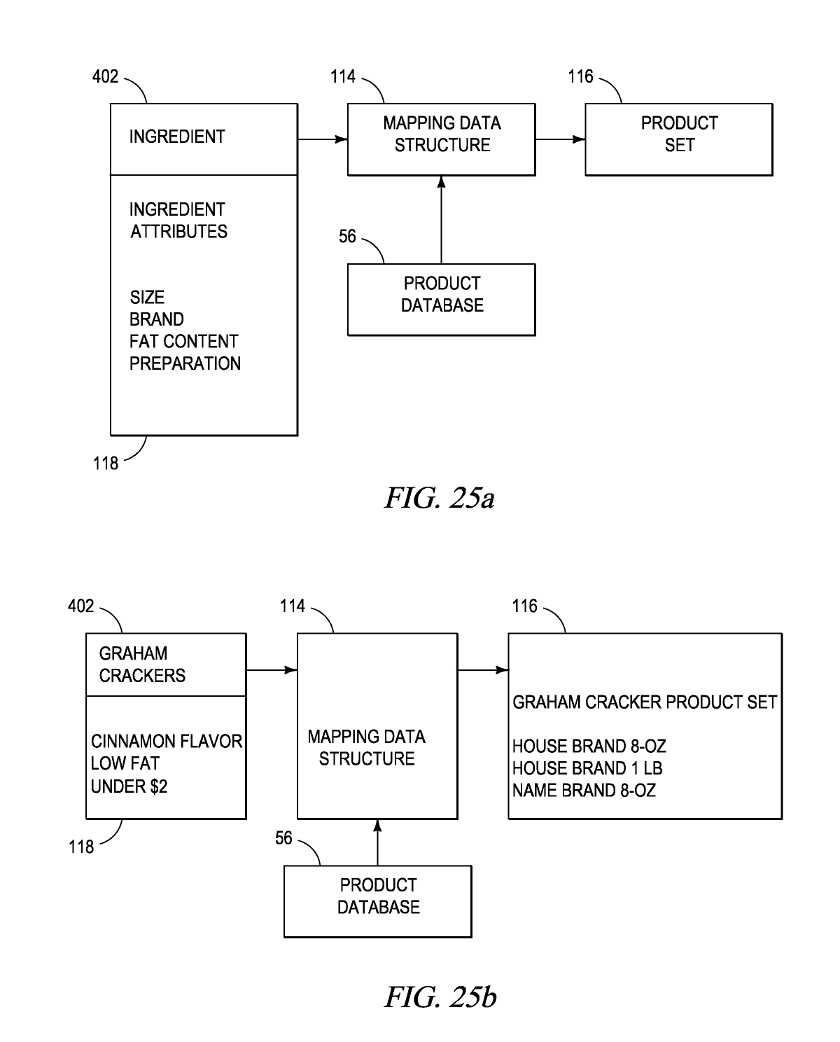

Consumer 44 selects add to list button 370 and is redirected to build shopping list webpage 170. Ingredients 402-406 on shopping list 198 function as items of interest 112. Each ingredient 402-406 has associated item attributes 118, used by mapping data structure 114 to generate product sets 116. FIG. 25a shows mapping data structure 114. Consumer service provider 52 provides mapping data structure 114 for linking ingredients 402-406 on shopping list 198 to specific product sets 116 interchangeable for each ingredient. Product set 116 functions as a set of substitutes, alternatives, replacements, choices, or options for each ingredient 402-406 on shopping list 198. Products 18 in product set 116 are interchangeable for ingredient 402. Ingredients 402-406 have associated item attributes 118. Mapping data structure 114 compares item attributes 118 of ingredients 402-406 to attributes of all potentially matching products 410-414 to determine whether a given product 410 will be placed in product set 116 corresponding to each ingredient. Mapping data structure 114 retrieves product information for all varieties of ingredient 402 from product database 56. Mapping data structure 114 uses the product attributes stored in product database 56, maintained by consumer service provider 52, to evaluate whether a given product 18 possesses the desired item attributes 118 and should be placed in product set 116 corresponding to ingredient 402. For example, ingredient 402 is graham crackers. Shopping list 198 contains graham crackers 402. Graham crackers 402 have item attributes 118 of cinnamon flavor, low fat and under two dollars per box.

Each actual variety of graham cracker, i.e., house brand teddy bear shaped graham crackers in an 11-ounce box, is a specific product 18. Mapping data structure 114 places varieties of graham crackers that possess the desired item attributes 118 of cinnamon flavor, low fat and under two dollars per box in graham cracker product set 116. Mapping data structure 114 does not place varieties of graham cracker that do not possess the desired item attributes 118 of cinnamon flavor, low fat and under two dollars per box in graham cracker product set 116. For example, mapping data structure 114 accesses product database 56, maintained by consumer service provider 52. Mapping data structure 114 retrieves product information for all varieties of graham crackers 18. Mapping data structure 114 retrieves product attributes stored in product database 56 regarding house brand eight-ounce box of cinnamon graham crackers 18. Mapping data structure 114 compares the product attributes stored in product database 56 regarding house brand eight-ounce box of cinnamon graham crackers to desired item attributes 118. Mapping data structure 114 determines that house brand eight-ounce box of cinnamon graham crackers 18 possesses the desired item attributes 118 of cinnamon flavor, low fat and under two dollars per box and places house brand eight-ounce box of cinnamon graham crackers in graham cracker product set 116. Mapping data structure 114 retrieves product attributes stored in product database 56 regarding name brand eight-ounce box of cinnamon graham crackers 18. Mapping data structure 114 compares the product attributes stored in product database 56 regarding name brand eight-ounce box of cinnamon graham crackers 18 to desired item attributes 118. Mapping data structure 114 determines that name brand eight-ounce box of cinnamon graham crackers 18 possesses the desired item attributes 118 of cinnamon flavor, low fat and under two dollars per box and places name brand eight-ounce box of cinnamon graham crackers in graham cracker product set 116. Mapping data structure 114 retrieves product attributes stored in product database 56 regarding house brand one-pound box of cinnamon graham crackers 18. Mapping data structure 114 compares the product attributes stored in product database 56 regarding house brand one-pound box of cinnamon graham crackers 18 to desired item attributes 118. Mapping data structure 114 determines that house brand one-pound box of cinnamon graham crackers 18 possesses the desired item attributes 118 of cinnamon flavor, low fat and under two dollars per box and places house brand one-pound box of cinnamon graham crackers in graham cracker product set 116.

In contrast, mapping data structure 114 retrieves product attributes stored in product database 56 regarding house brand eight-ounce box of chocolate graham crackers 18. Mapping data structure 114 compares the product attributes stored in product database 56 regarding house brand eight-ounce box of chocolate graham crackers 18 to desired item attributes 118. Mapping data structure 114 determines that house brand eight-ounce box of chocolate graham crackers 18 does not possess the desired item attribute 118 of cinnamon flavor and does not place house brand eight-ounce box of chocolate graham crackers in graham cracker product set 116. Mapping data structure 114 retrieves product attributes stored in product database 56 regarding name brand eight-ounce box of chocolate graham crackers 18. Mapping data structure 114 compares the product attributes stored in product database 56 regarding name brand eight-ounce box of chocolate graham crackers 18 to desired item attributes 118. Mapping data structure 114 determines that name brand eight-ounce box of chocolate graham crackers 18 does not possess the desired item attribute 118 of cinnamon flavor and does not place name brand eight-ounce box of chocolate graham crackers in graham cracker product set 116. Mapping data structure 114 retrieves product attributes stored in product database 56 regarding name brand one-pound box of cinnamon graham crackers 18. Mapping data structure 114 compares the product attributes stored in product database 56 regarding name brand one-pound box of cinnamon graham crackers 18 to desired item attributes 118. Mapping data structure 114 determines that name brand one-pound box of cinnamon graham crackers 18 does not possess the desired item attribute 118 of under two dollars per box and does not place name brand one-pound box of cinnamon graham crackers in graham cracker product set 116.

Graham cracker product set 116 contains products 18 that function as substitutes, alternatives, replacements, choices, or options for graham crackers 402, as determined by mapping data structure 114 using data from product database 56 and item attributes 118. Products 18 in product set 116 are interchangeable for ingredient 402. FIG. 25b shows mapping data structure 114 linking specific ingredient graham crackers 402, to a specific set of products interchangeable for the ingredient, graham cracker product set 116. Mapping data structure 114 determines products 18 in graham cracker product set 116 based on ingredient attributes 118 and product information retrieved from product database 56, maintained by consumer service provider 52. Graham cracker product set 116 contains house brand eight-ounce box of cinnamon graham crackers 18, name brand eight-ounce box of cinnamon graham crackers, and house brand one-pound box of cinnamon graham crackers. Mapping data structure 114 links product set 116 to ingredient 402.

Most ingredient lists 356 have more than one ingredient 402. Mapping data structure 114 determines product set 116 corresponding to each ingredient 402-406 on ingredient list 356 using product attributes retrieved from product database 56 maintained by consumer service provider 52. Each product 18 in product set 116 functions as a substitute, alternative, replacement, choice, or option for each ingredient 402-406 on shopping list 198. Products 18 in product set 116 are interchangeable for ingredient 402. Mapping data structure 114 determines product set 116 corresponding to each ingredient 402-406 on shopping list 198.

Intelligent personal agent prepopulates shopping list 198 with ingredients 402-406 from recipe 292 for S'mores, i.e., graham crackers, chocolate bars, and marshmallows. Consumer 44 does not need to enter ingredients 402-406 from recipe 292 for S'mores, i.e., graham crackers, chocolate bars, and marshmallows onto shopping list 198. Intelligent personal agent 54 places each ingredient, i.e., graham crackers, chocolate bars, and marshmallows on shopping list 198 before presenting the shopping list to consumer 44. Mapping data structure 114 identifies product sets 116 corresponding to each ingredient 402-406 on shopping list 198 before presenting the shopping list to consumer 44.

In addition to ingredients 402-406 needed to make S'mores, i.e., graham crackers, chocolate bars, and marshmallows, consumer 44 intends to buy other groceries. For example, later in the week consumer 44 intends to make a pasta dish. Consumer 44 adds items 112 required to make the pasta dish to shopping list 198, already containing ingredients 402-406, i.e., graham crackers, chocolate bars, and marshmallows, added by intelligent personal agent 54. Consumer 44 finishes building shopping list 198 with items 112. FIG. 13 shows webpage 170 provided for building shopping list 198. Webpage 170 presents categories of grocery items. A category is presented for each type of grocery item. Consumer 44 completes shopping list 198 by adding items 112 to list 198. Consumer 44 selects button 172 to select the baking product family. Consumer 44 adds olive oil 112 to list 198. Consumer 44 adds garlic 112 to shopping list 198 directly by typing garlic into block 186. Consumer 44 saves shopping list 198 by selecting button 192. Consumer service provider saves shopping list 198 in product database 56.

Once consumer 44 has built combined shopping list 198, the consumer assigns weighted product attributes to items 112 and ingredients 402-406 on the combined list 198. Each item 112 and ingredient 402-406 on list 198 has item attributes 118. Consumer 44 assigns a weight to each item attribute 118 based on personal consumer preference. The consumer item attribute 118 weighting factors reflect the level of importance or preference that consumer 44 bestows on each item attribute 118. The available item attributes 118 include product-specific attributes, diet/health/nutrient related product attributes, lifestyle related product attributes, environment related product attributes, allergen related product attributes, and social/society related product attributes. The item attributes 118 also include brand, ingredients, grade, size, price, freshness, retailer preference, warranty, and the like. Consumer 44 assigns weights to item attributes 118 of products on list 198 using product family buttons 172-182 from build shopping list webpage 170 shown in FIG. 13, for example, baking product family button 172.

Marshmallows are in the baking products family. Consumer 44 sets the item attributes 118 and weighting factors for marshmallow product set 116. Consumer 44 indicates that the consumer will only purchase large marshmallows that have six or more weeks remaining until the expiration date. Consumer 44 sets the weighting factor for the freshness item attribute 118 for marshmallows to the maximum value because the consumer is greatly concerned with the freshness of marshmallows. Consumer 44 indicates that the consumer prefers to purchase large marshmallows from a major national brand manufacturer 22. Consumer 44 sets the weighting factor for the brand item attribute 118 for marshmallows to a mid-range value because the consumer is mildly concerned with the brand of marshmallows. Consumer 44 will buy large marshmallows from an off brand if all acceptable retailers 46-50 are out of stock of fresh packages of the name brand large marshmallows. Consumer 44 sets the weighting factor for the price item attribute 118 for large marshmallows to the minimum value because the consumer is negligibly concerned with the price of large marshmallows. Once the item attributes 118 and weighting factors for all baking products 410-414, i.e., marshmallows, are defined by consumer preference, consumer 44 makes selections for the next product category; for example, the cracker family.

Graham crackers are in the cracker family. Consumer 44 sets the item attributes 118 and weighting factors for graham cracker product set 116. Consumer 44 sets the weighting factor for the price item attribute 118 for graham crackers to the maximum value because the consumer is greatly concerned with the price of graham crackers. Consumer 44 indicates that the consumer prefers to purchase graham crackers that have two or more weeks remaining until the expiration date. Consumer 44 sets the weighting factor for the freshness item attribute 118 for graham crackers to a mid-range value because the consumer is mildly concerned with the freshness of graham crackers. Consumer 44 indicates that the consumer prefers to purchase graham crackers from a major national brand manufacturer 22. However, consumer 44 sets the weighting factor for the brand item attribute 118 for graham crackers to the minimum value because the consumer is negligibly concerned with the brand of graham crackers. Once the item attributes 118 and weighting factors for all cracker family products 410-414, i.e., graham crackers, are defined by consumer preference, consumer 44 makes selections for the next product category; for example, the candy family.

Chocolate bars are in the candy family. Consumer 44 sets the item attributes 118 and weighting factors for chocolate bar product set 116. Consumer 44 sets the weighting factor for the percent cocoa item attribute 118 for chocolate bars to the maximum value because the consumer is greatly concerned with the cocoa content of chocolate bars. Consumer 44 sets the weighting factor for the cost item attribute 118 for chocolate bars to a mid-range value because the consumer is mildly concerned with the cost of chocolate bars. Consumer 44 indicates that the consumer prefers to purchase chocolate bars from a major national brand manufacturer 22. However, consumer 44 sets the weighting factor for the brand item attribute 118 for chocolate bars to the minimum value because the consumer is negligibly concerned with the brand of chocolate bars. Once the item attributes 118 and weighting factors for all candy family products, i.e., chocolate bars, are defined by consumer preference, consumer 44 selects for the next product category. Once the item attributes 118 and weighting factors for all items 112 and ingredients 402-406 on shopping list 198 are defined by consumer preference, intelligent personal agent 54 is ready to create optimized shopping list 110.

Intelligent personal agent 54 uses consumer defined consumer requirement set 416 to filter products 18 in each product set 116 generated by mapping data structure 114. Specifically, intelligent personal agent 54 accesses consumer requirement set 416 stored in product database 56 to retrieve explicit consumer-specified criteria. For example, consumer 44 indicates in product consideration set 416 that consumer 44 only purchases dark chocolate products 410-414. Recipe 292 for S'mores does not indicate whether ingredient chocolate bar 404 should be dark chocolate. Nevertheless, intelligent personal agent 54 only considers dark chocolate products 410-414 for consumer 44 when consumer 44 indicates an intent to purchase a chocolate product 410. All chocolate bar products 410-414 that do not meet the consumer requirement of dark chocolate are removed from chocolate bar product set 116. Thus, only dark chocolate bars remain in chocolate bar product set 116 on shopping list 198 for consumer 44. Intelligent personal agent 54 removes all chocolate bars 18 from product set 116 that do not meet the specific consumer requirement of dark chocolate required by consumer 44. Consumer 44 views optimized shopping list 110 by clicking on view shopping list button 190 in FIG. 13. Optimized shopping list 110 is presented to consumer 44 on optimized shopping list webpage 260 shown in FIG. 16.

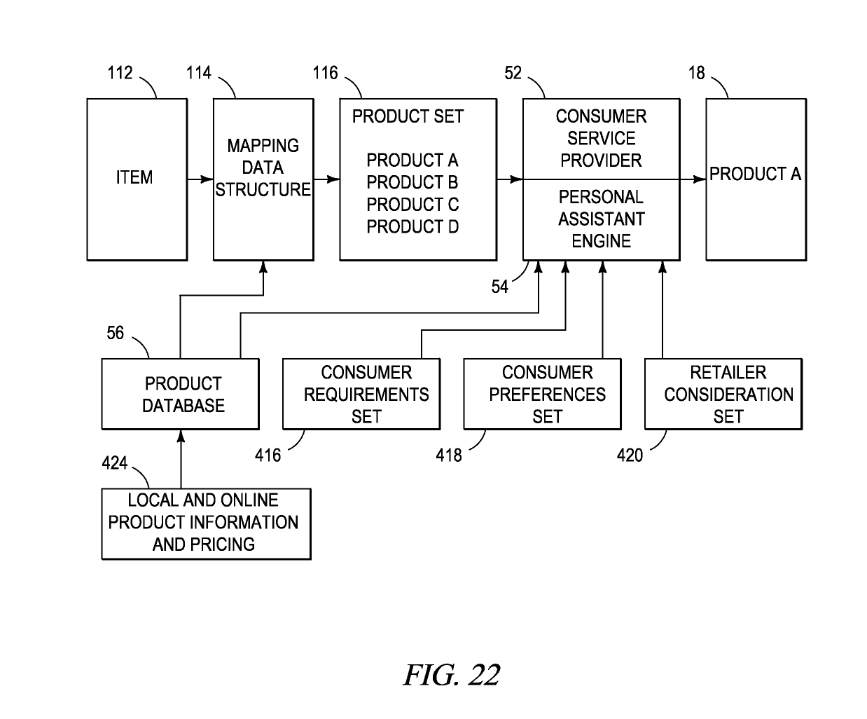

Based on the consumer-generated initial list of items 112 and ingredients 402-406 and the consumer-defined item attributes 118 and weighting factors, intelligent personal agent 54 executes a comparative shopping service to optimize shopping list 198 and select which products 410-414 should be purchased from which retailers 46-50 on which day to maximize the value to consumer 44 as defined by the consumer profile and weighted attributes. Intelligent personal agent 54 selects one product 18 from each product set 116 corresponding to the maximum value to consumer 44. Intelligent personal agent 54 places the selected product 18 from each product set 116 corresponding to the maximum value to consumer 44 on optimized shopping list 110. Alternatively, intelligent personal agent 54 selects one or more products 410-414 that meet or exceed a consumer satisfaction threshold as defined by shopping list 198 and consumer-defined item attribute 118 weights from product set 116 and places the selected product or products on optimized shopping list 110. Intelligent personal agent 54 considers consumer-weighting factors for item attributes 118 and specific consumer requirements when selecting products 410-414 from each product set 116. FIG. 22 shows intelligent personal agent 54 generating optimized shopping list 110. Intelligent personal agent 54 uses consumer preference set 418 stored in product database 56, maintained by consumer service provider 52 to determine a value consumer 44 places on each product 410-414. Product database 56 contains local and online product information and pricing 424, maintained by consumer service provider 52. Intelligent personal agent 54 considers retailer consideration set 420 from product database 56, maintained by consumer service provider 52 to determine which retailers 46-50 are acceptable to consumer 44. Intelligent personal agent 54 optimizes list 198 by selecting one product 18 from each product set 116 corresponding to each item 112 and ingredient 402-406 on shopping list 198 based on maximizing value to consumer 44. The selected product 18 in each product set 116 corresponding to each item 112 or ingredient 402-406 which maximizes the satisfaction of consumer 44 is placed on optimized shopping list 110.

Optimized shopping list 110 is presented to consumer 44 on optimized shopping list webpage 260 shown in FIG. 16. Optimized shopping list 110 includes products 410-414 from product sets 116 corresponding to ingredients 402-406 imported from recipe 292, i.e., graham crackers, chocolate bars, and marshmallows. A list of retailers 46-50 to be patronized is shown in block 262, based on products 410-414 contained in optimized shopping list 110. Images and descriptions are shown in block 264. Consumer 44 modifies optimized shopping list 110, as well as the consumer item attribute 118 weighting factors, with add button 266, update button 268, or delete button 270.

Once optimized shopping list 110 has been generated, consumer 44 travels to local retailers 46-50 and accesses optimized shopping list 110. Consumer 44 purchases the goods, including products 410-414 corresponding to ingredients 402-406 from recipe 292, i.e., 13 ounce house brand graham crackers, 4.25 ounce Hershey's® brand dark chocolate bars, and 10 ounce house brand large marshmallows. Consumer 44 generates an activity within commerce system 40 by purchasing the goods based on the recommendations of consumer service provider 52 and intelligent personal agent 54. Consumer 44 may access optimized shopping list 110 on his or her cell phone 66. Alternatively, consumer 44 may print out a copy of optimized shopping list 110 from webpage 260 and bring the print out to local retailers 46-50. However, if product 412, 4.25 ounce Hershey's® brand dark chocolate bars, is unfamiliar to consumer 44, intelligent personal agent 54 assists consumer 44 in finding the specific product aisle and shelf location of the product at retailer 46.

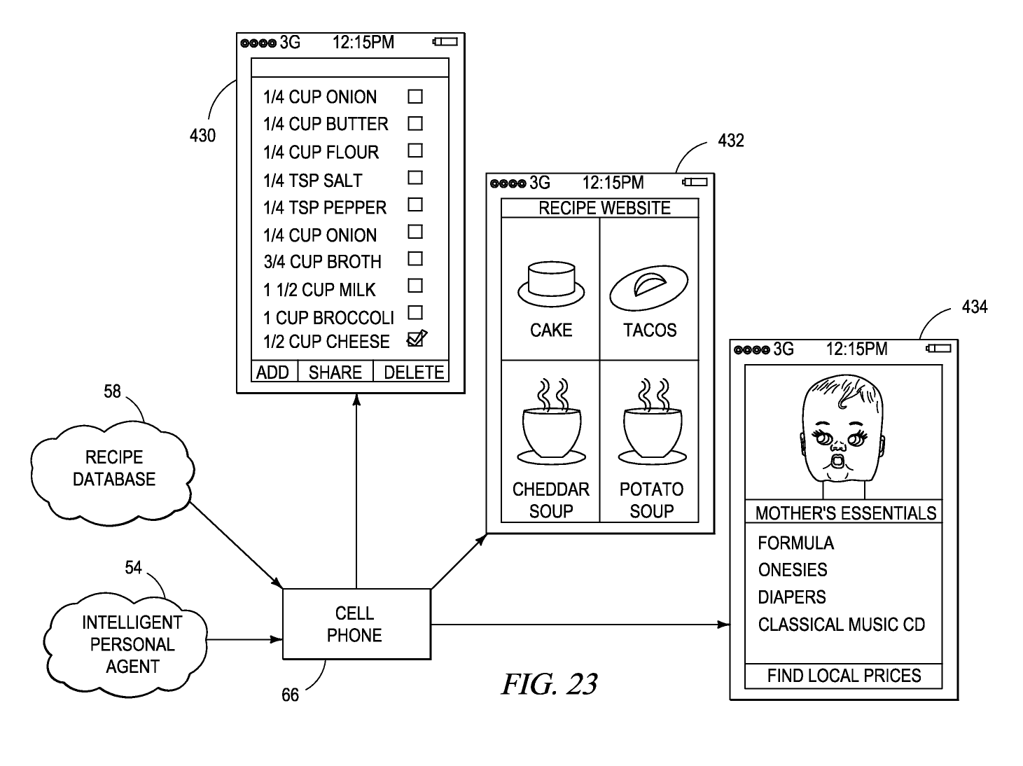

Consumers 42-44 access intelligent personal agent 54 and recipe database 58 from cell phones 66 running mobile apps. FIG. 23 shows examples of screen shots from cell phone 66. Screen shot 430 is an example of ingredient list 356. Screen shot 432 is an example of a display of recipe photos. Screen shot 434 is an example of shared list 108.

Consumer service provider 52 helps retailers 30 and 46-50, as well as consumers 42-44. Retailer 30 has an excess inventory of chicken stock and needs to increase sales of chicken stock. Retailer 30 shares a recipe for One Pan Pasta, featuring chicken stock, on the website of retailer 30. Retailer 30 adds new recipe 294 for One Pan Pasta to recipe database 58 by selecting enter new recipe button 326 on recipe webpage 290. Recipe database 58, maintained by consumer service provider 52, stores searchable information about each recipe 292-296 such as a title 342, brief description 344, allergy information 346, nutritional information 348, number of servings 350, serving size 352, consumer rating 354, ingredient list 356, photograph 358, cooking instructions 360, community rating 361, notes 362, and contributor 368. Recipe database 58 stores recipe information such that recipes 292-296 are searchable based on key ingredients 402-406, keywords 342-344, allergy information 346, categories 304-312, meals 314-322, and other criteria. Selecting new recipe button 326 brings up individual recipe webpage 340. Retailer 30 selects title block 342 to enter the title for recipe 294 and enters One Pan Pasta into the title block. Retailer 30 selects brief description block 344 to enter the brief description for recipe 294 and enters fall favorite into the brief description block. Retailer 30 selects contributor block 368 to enter the contributor for recipe 294 and enters retailer 30 into the contributor block. Retailer 30 selects serving size block 352 to enter the serving size for recipe 294 and enters 1 cup into the serving size block. Retailer 30 selects number of servings block 350 to enter the number of servings for recipe 294 and enters 6 servings into the number of servings block. Retailer 30 selects cooking instructions block 360 to enter the cooking instructions for recipe 294 and enters ‘simmer all ingredients for 30 minutes’ into the cooking instructions block. Retailer 30 selects consumer-rating block 354 to enter the consumer rating for recipe 294 and enters five stars into the consumer-rating block. Retailer 30 selects note block 362 to enter the note for recipe 294 and enters ‘Retailer 30 has chicken stock on sale this week’ into the note block. Retailer 30 selects ingredient list block 356 to enter ingredient list 356 for recipe 294, as explained below. Retailer 30 selects save recipe button 366 to save recipe 294. Consumer service provider 52 saves recipe 294 in recipe database 58. Retailer 30 selects share recipe button 364 to share recipe 294.

Returning to FIG. 21, to enter list 73 of ingredients 402-406 for recipe One Pan Pasta, retailer 30 navigates to ingredient list webpage 380 from individual recipe webpage 340 for One Pan Pasta. Retailer 30 selects add ingredient button 394 from ingredient list webpage 380. Ingredient block 402 for entry of ingredient information is provided. For example, one of ingredients 402-406 in recipe 294 for One Pan Pasta is garlic. Ingredient garlic 402 has name 388 garlic, modifier 386 minced, quantity 382 of 3 and unit 384 cloves. Retailer 30 enters the garlic information in ingredient block 402 and selects add ingredient button 394 to bring up new ingredient block 404. Ingredient chicken stock 404, also in recipe 294 for One Pan Pasta, has name 388 chicken stock, quantity 382 of 3, and unit 384 cups. Retailer 30 enters the chicken stock information in ingredient block 404 and selects add ingredient button 394 to bring up new ingredient block 406. Ingredient olive oil 406 has name 388 olive oil, quantity 382 of 2, and unit 384 tbsp. Retailer 30 enters the olive oil information in ingredient block 406. Ingredient olive oil is generic. In one embodiment, brand identifier 390 of ingredient olive oil 406 is left blank, as is brand lock 392. In another embodiment, brand identifier 390 of ingredient olive oil 406 is set to generic and brand lock 392 is configured to allow for substitutions. In another embodiment, brand identifier 390 is set to a specific brand name and brand lock 392 is set to either allow or suppress substitutions. Retailer 30 selects delete row button 398 to delete a row. When all ingredients 402-406 for recipe 294 are correct, retailer 30 selects save ingredient list button 396 to save ingredient list 356. Consumer service provider 52 saves ingredient list 356 in recipe database 58. Recipe database 58 associates ingredient list 356 with recipe 294. Recipe database 58 stores recipe information such that recipes 292-296 are searchable based on key ingredients 402-406, keywords 342-344, allergy information 346, categories 304-312, meals 314-322, and other criteria. Retailer 30 shares ingredient list 356 by selecting share list button 400.

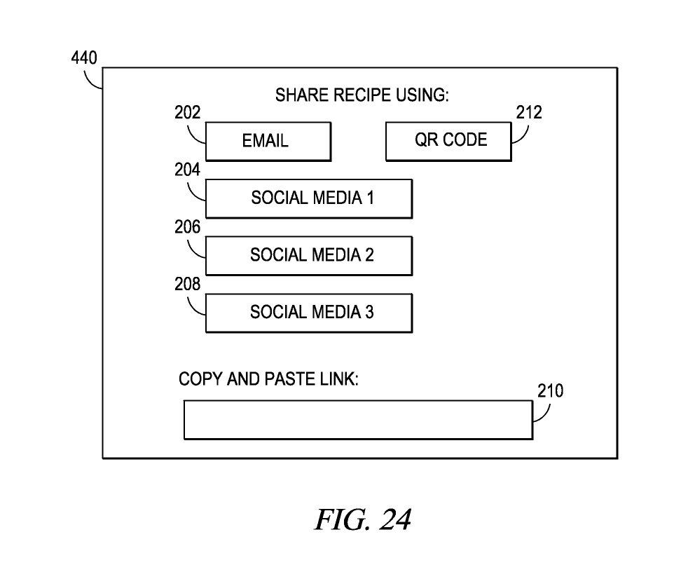

As shown in FIG. 20, selecting share recipe button 364 from individual recipe webpage 340 brings up share recipe webpage 440. FIG. 24 shows an example of share recipe webpage 440. Consumers 42-44 and retailer 30 share recipes 292-296 in a variety of ways. Retailer 30 generates an email by selecting email button 202. Consumers 42-44 post recipes 292-296 on various social media websites by selecting social media buttons 204-208. Retailer 30 copies and pastes URL link 106 to recipe 294 for One Pan Pasta by copying the text in URL block 210. Retailer 30 shares recipe 294 for One Pan Pasta, featuring chicken stock, on the website of retailer 30 using URL link 106, generated by consumer service provider 52. Retailer 30 generates QR code 280 by selecting QR code button 212. Retailer 30 places print add 37 including QR code 280 in a local newspaper to encourage consumers 42-44 to read recipe 294 for One Pan Pasta and buy chicken stock from the retailer. Thus retailer 30 increases sales of chicken stock using recipe sharing enabled by consumer service provider 52.

Consumers 42-44 and retailers 46-50 share recipes. Consumer 42 previously entered recipe 292 for S'mores into recipe database 58. Now consumer 42 shares recipe 292 on his or her personal page of a social media website. Consumer 42 selects social media 1 button 204 on share recipe webpage 440 to share recipe 292 for S'mores on his or her personal page of a popular social media website. If consumer 44 and consumer 42 are friends, consumer 44 sees recipe 292 posted on the social media personal page of consumer 42 and follows URL link 106 to individual recipe webpage 340 shown in FIG. 20. If consumer 44 does not see link 106 to recipe 292 for S'mores posted online, consumer 44 accesses recipe 292 by browsing recipe database 58 as described above. Alternatively, consumer 44 accesses recipe 292 for S'mores by requesting recipe suggestions from intelligent personal agent 54. Intelligent personal agent 54 suggests recipes 292-296 for consumers 42-44 based on various inputs. One input is household inventory list 444.

Consumer service provider 52 maintains household inventory list 444, shown in FIG. 22, for each consumer 42-44, using intelligent personal agent 54. Intelligent personal agent 54 adds products 410-414 from optimized shopping list 110, or from actual transaction history, to household inventory list 444. Consumer 42 enters products 410-414 onto household inventory list 444 in any manner described herein for entering products 410-414 onto lists 73. For example, consumer 42 scans the UPC symbols from products 410-414 in the pantry of consumer 42 with cell phone 66 and intelligent personal agent 54 decodes the UPC and adds the products to household inventory list 444. Consumer 42 deletes products 410-414 from household inventory list 444 as the products are consumed. Consumer 42 instructs intelligent personal agent 54 to suggest recipes 292-296 in recipe database 58 that may be prepared using products 410-414 from household inventory list 444 by selecting household inventory button 300 from recipe webpage 290. Mapping data structure 114 maps each product 410-414 to item 112. Intelligent personal agent 54 makes recipe recommendations by comparing items 112 on household inventory list 444 to ingredients 402-406 in ingredient lists 356. Consumer service provider 52 saves consumers 42-44 money by helping consumers 42-44 to prepare meals using food already purchased before the food goes to waste. Intelligent personal agent 54 and mapping data structure 114 rely on data maintained by consumer service provider 52 in product database 56 and recipe database 58.

FIG. 19 shows recipe webpage 290. Recipe webpage 290 displays favorite recipes 292-296. Consumer 42 uses recipe webpage 290 to browse recipes 292-296 or seek recipe suggestions from intelligent personal agent 54. Consumer 44 instructs intelligent personal agent 54 to suggest recipes 292-296 in recipe database 58 that may be prepared using items from current shopping list 198 by selecting current shopping list button 298. Consumer 42 has turkey and noodles on his or her current shopping list 198 and selects current shopping list button 298. Intelligent personal agent 54 searches recipe database 58 and presents recipe 74 for Turkey Noodle Soup to consumer 42.

Alternatively, consumer 42 plans to try something entirely new. Consumer 42 instructs intelligent personal agent 54 to suggest recipes 292-296 in recipe database 58 that use any selected item 112 by selecting key ingredient button 302. Consumer 42 is intrigued about new item 112, quinoa for example, because recent media coverage has extolled the health virtues of the new product. However, consumer 42 is not likely to purchase new item 112 unless the consumer has a way to incorporate the new product into meals. Alternatively, item 112 is a kitchen implement, such as a mandolin slicer. Intelligent personal agent 54 assists consumer 42 by suggesting recipes 292-296 to incorporate new product 410 into meals using key ingredient button 302. For example, when consumer 42 selects key ingredient button 302 and enters quinoa, intelligent personal agent 54 searches recipe database 58 for recipes 292-296 featuring quinoa and presents recipe 296 for Quinoa Tabbouleh to consumer 42 on recipe webpage 290. When consumer 42 selects key ingredient button 302 and enters mandolin slicer, intelligent personal agent 54 searches recipe database 58 for recipes 292-296 requiring a mandolin slicer and presents recipe 292 for Scalloped Potatoes to consumer 42 on recipe webpage 290. Additionally, recipe webpage 290 is used to search recipe database 58 either by keyword searching using keyword block 324 or by category browsing using category blocks 304-322, as described above.

Consumer 42 plans to prepare dinner using some ingredients 402-406 already in his or her pantry. Consumer 42 has four cans of chicken stock on his or her household inventory list 444. Consumer 42 finds recipe 294 for One Pan Pasta contributed by retailer 30 in recipe database 58 by selecting household inventory button 300. Consumer 42 reads recipe 294 for One Pan Pasta and decides to make it. Consumer 42 selects add to list button 370 and is redirected to build shopping list webpage 170. Shopping list 198 is prepopulated with ingredients 404-406 from recipe 294 other than the ingredients present on household inventory list 444, i.e., olive oil and garlic. Consumer 42 does not need to purchase ingredients 402, chicken stock, present on household inventory list 444 because consumer 42 already possesses chicken stock. Intelligent personal agent removes ingredient chicken stock 402 from shopping list 198 before presenting the shopping list to consumer 42.

Intelligent personal agent 54 uses consideration sets to generate optimized shopping list 110. Retailer consideration set 420 articulates the value consumer 42 places on shopping at a specific retailer 46. Some consumers 42-44 prefer to do all the weekly shopping at a single retailer 46, while other consumers 14 and 34 prefer to get the best value on each product 410-414, even if it means traveling to four different retailers 30 and 46-50. Consumer preferences are recorded as product consideration sets 416-418 and retailer consideration sets 420. Product consideration sets 416 are created using product attributes or consumer preferences. For example, consumer 42 indicates that consumer 42 only purchases organic food products 410-414. Consumer 42 imports ingredient list 356 including tomatoes from recipe 74 for Turkey Noodle Soup. Recipe 74 for Turkey Noodle Soup does not indicate whether ingredient tomatoes 402 should be organic. Nevertheless, intelligent personal agent 54 only considers organic food products 410-414 for consumer 42 when consumer 42 indicates an intent to purchase food product 18. Thus, only tomato products 18 with item attribute 118 organic are placed on optimized shopping list 110 for consumer 42. Consumer service provider 52 saves consideration sets in product database 56 for future use. Intelligent personal agent 54 considers product consideration sets 416-418 and specific consumer requirements when selecting products 410-414 from each product set 116.

Mapping data structure 114 also uses product attributes and weighting factors stored in product database 56 to select products 410-414 for product sets 116. Consumer service provider 52 operates and maintains mapping data structure 114 for linking items 112 or ingredients 402-406 to a set of products 116. Mapping data structure 114 maps products 410-414 to ingredients 402-406 and ultimately to recipes 292-296. Mapping data structure 114 relies on data maintained by consumer service provider 52 in product database 56 and recipe database 58. Mapping data structure 114 accesses product information including item attributes 118 and weighting factors from product database 56 and ingredient information from recipe database 58. Mapping data structure 114 compares item attributes 118 of each ingredient 402-406 to attributes of all potential products 410-414 to determine whether a given product 410 will be placed in product set 116 corresponding to ingredient 402 in recipe 74 for Turkey Noodle Soup. For example, if ingredient tomatoes 402 has modifier chopped, mapping data structure 114 may add canned whole tomatoes 410 and canned diced tomatoes 412 to tomatoes product set 116. However, if ingredient tomatoes 402 has modifier whole, mapping data structure 114 will not add canned diced tomatoes 412 to tomato product set 116, because canned diced tomatoes 412 does not have required item attribute 118 of whole. Whole tomatoes may be chopped, but diced tomatoes may not be made whole. Mapping data structure 114 will add canned whole tomatoes 410 to tomato product set 116.

Mapping data structure 114 evaluates the quantity 382 and unit 384 of ingredient 402 and compares the requirement with the size of product 410 to calculate the number of units of product 410 that must be added to product set 116 to provide a sufficient quantity of ingredient 402 to make recipe 74 for Turkey Noodle Soup. For example, recipe 74 for Turkey Noodle Soup calls for three cups of ingredient chicken stock 402. Ingredient chicken stock 402 has name 388 chicken stock, quantity 382 of 3 and unit 384 cups. Mapping data structure 114 searches product database 56 and identifies two products 410-412 that may serve as ingredient chicken stock 402 in recipe 74 for Turkey Noodle Soup which are available at retailers 46-50, acceptable to consumer 42. The first product is house brand canned chicken stock 410. It has a package size of 14.5 ounces per can. Mapping data structure 114 converts ounces to cups and calculates that two cans of house brand canned chicken stock 410 are required to provide sufficient chicken stock to prepare Turkey Noodle Soup. (3 cups*1 can/14.5 ounces*8 ounces/cup=1.65 cans.) Mapping data structure 114 rounds up from 1.65 cans to two cans. Mapping data structure 114 puts 2 cans of house brand canned chicken stock 410 in chicken stock product set 116. The second product is house brand boxed chicken stock 412. It has a package size of one quart per box. Mapping data structure 114 converts quarts to cups and calculates that one box of house brand boxed chicken stock 412 is required to provide sufficient chicken stock to prepare Turkey Noodle Soup. (3 cups*1 box/1 quart*1 quart/4 cups=0.75 boxes.) Mapping data structure 114 rounds up from 0.75 boxes to one box. Mapping data structure 114 puts 1 box of house brand boxed chicken stock 412 in chicken stock product set 116. Mapping data structure 114 relies on data maintained by consumer service provider 52 in product database 56 and recipe database 58 to select products 410-414 to include in product sets 116.

In one embodiment, intelligent personal agent 54 considers consumer weighted product attributes to select product 410 or 412 based on consumer preferences to place on optimized shopping list 110. In another embodiment, retailers 46-50 acceptable to consumer 42 are out of stock of products 410-412 that are interchangeable with ingredient chicken stock 402. Mapping data structure 114 uses product information maintained by consumer service provider 52 in product database 56 including product families to suggest available substitute products 18 and 414 for unavailable ingredient chicken stock 402; for example, house brand canned beef stock 18 or house brand boxed vegetable stock 414.

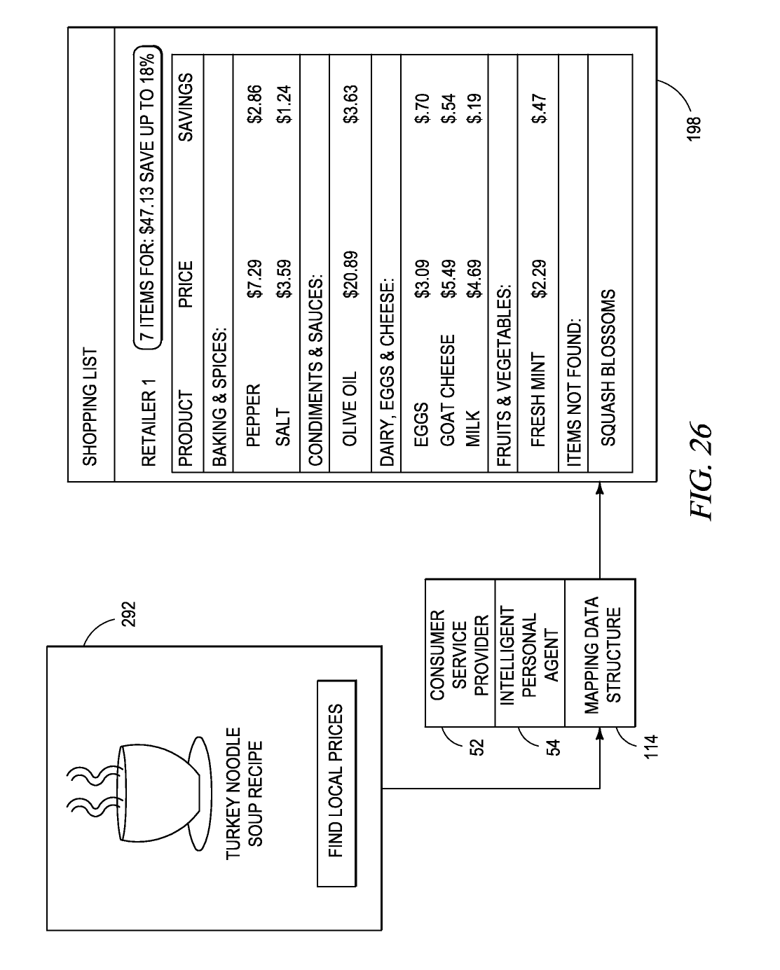

Once mapping data structure 114 has determined products sets 116 corresponding to ingredients 402-406, the ingredients are added to shopping list 198, as shown in FIG. 26. Consumer 42 defines acceptable local retailers 46-50 using webpage 230 as described above. Consumer 42 finishes building shopping list 198 using build shopping list webpage 170, as described above. Intelligent personal agent 54 selects one or more products 410-414 that meet or exceed a consumer satisfaction threshold as defined by shopping list 198 and consumer-defined item attribute 118 weights from product set 116 and places the selected product or products on optimized shopping list 110. Intelligent personal agent 54 considers consumer-weighting factors for item attributes 118 and specific consumer requirements when selecting product or products 410-414 from each product set 116. Alternatively, intelligent personal agent 54 selects one product 18 from each product set 116 corresponding to each item 112 on shopping list 198 to maximize the value to or satisfaction of consumer 42. Intelligent personal agent 54 optimizes list 198 by considering product set 116 corresponding to each item 112 and ingredient 402-406 on shopping list 198 from webpage 170 and reviewing retailer product information in product database 56 to determine how to select the optimal product 18 from retailers 46-50 for each product set 116. Intelligent personal agent 54 accesses product database 56 to retrieve available discounts for each product 18 in product set 116. Intelligent personal agent 54 associates a discount with each product 18 in product set 116. The discount could be no discount, a percentage of the retail price, or an amount, i.e., fifty cents. Retailer 46, manufacturer 22, or distributor 26, provide the discount or discounts on product 18. The discount may be available to all consumers 42-44 or the discount may be an individualized offer negotiated by intelligent personal agent 54 for consumer 42. Intelligent personal agent 54 selects one discounted product 18 from the product set 116 chosen to generate a positive purchasing decision by consumer 42. Intelligent personal agent places the selected discounted product on optimized shopping list 110. Optimized shopping list 110 is presented to consumer 42 on optimized shopping list webpage 260 shown in FIG. 16. Optimized shopping list 110 includes products 410-414 from product sets 116 corresponding to ingredients 402-406 imported from recipe 74 for Turkey Noodle Soup.

Consumer 42 patronizes retailers 46-50, either in person or online, with optimized shopping list 110 including products 410-414 from product sets 116 corresponding to ingredients 402-406 in recipe 74 for Turkey Noodle Soup in hand and makes purchasing decisions based on the recommendations on optimized shopping list 110. Consumers 42-44 benefit from the boom in recipe sharing by easily finding new recipes 292-296 and ingredients 402-406 for recipes 74 and 292-296 using optimized shopping lists 110 based on the individual preferences and requirements of consumers 42-44 at retailers 46-50 local to consumers 42-44.

Retailers 46-50, manufacturers 22, and distributors 26 benefit from the boom in online recipe 74 and list 73 sharing as well. Retailers 46-50, manufacturers 22, and distributors 26 target marketing funding by offering incentives for contributors 104 who drive incremental purchases of specific branded products 410-414. Contributors 104 learn about the incentives from consumer service provider 52, and generate and post lists 73 and recipes 74 to earn the incentives.

Retailers 46-50, manufacturers, and distributors 26 are highly motivated to encourage widespread sharing of recipes 292-296 that feature the specific branded products 410-414. Retailers 46-50 offer incentives to generate recipes 292-296 containing specific house brand products 410-414, like Safeway® Lucerne® brand heavy whipping cream and Walmart® Great Value® brand frozen orange juice. Manufacturers 22 offer incentives to generate recipes 292-296 containing specific brand name products 410-414, like Betty Crocker® Bisquick® brand pancake and biscuit mix. Consumer service provider 52 allows contributor 104 to enable or disable brand substitution by configuring brand lock 392 when entering ingredient list 356 for recipe 292 into recipe database 58. When brand lock 392 is enabled, mapping data structure 114 only maps products 410-414 from product database 56 with a matching brand identifier 390. When brand lock 392 is disabled, mapping data structure 114 maps products 410-414 from product database 56 without regard to brand identifier 390. By enabling brand lock 392, consumer service provider 52 enables contributor 104 to increase demand for the specific branded products 410-414, because only products with the specific brand identifier 390 are selected for inclusion in product set 116.

Consumer service provider 52 tracks the number of times consumer 42 adds product 410 with a specific brand identifier to shopping list 198 of consumer 42. Website 100 tracks the number of times recipe 292 including a specific brand name ingredient 402 is viewed or shared. Retailer 30, manufacturer 22, or distributor 26 pays a fee to consumer service provider 52 each time consumer 42 places specific brand name ingredient 402 from ingredient list 356 onto shopping list 198 of consumer 42 or optimized shopping list 110 of consumer 42. Alternatively, the retailer 30, manufacturer 22, or distributor 26 pays a fee based on the number of times recipe 292 or list 108 including specific brand name ingredient 402 is viewed or shared. Consumer service provider 52 pays a fee to contributor 104 who contributed recipe 292 including specific brand name ingredient 402 to recipe database 58.

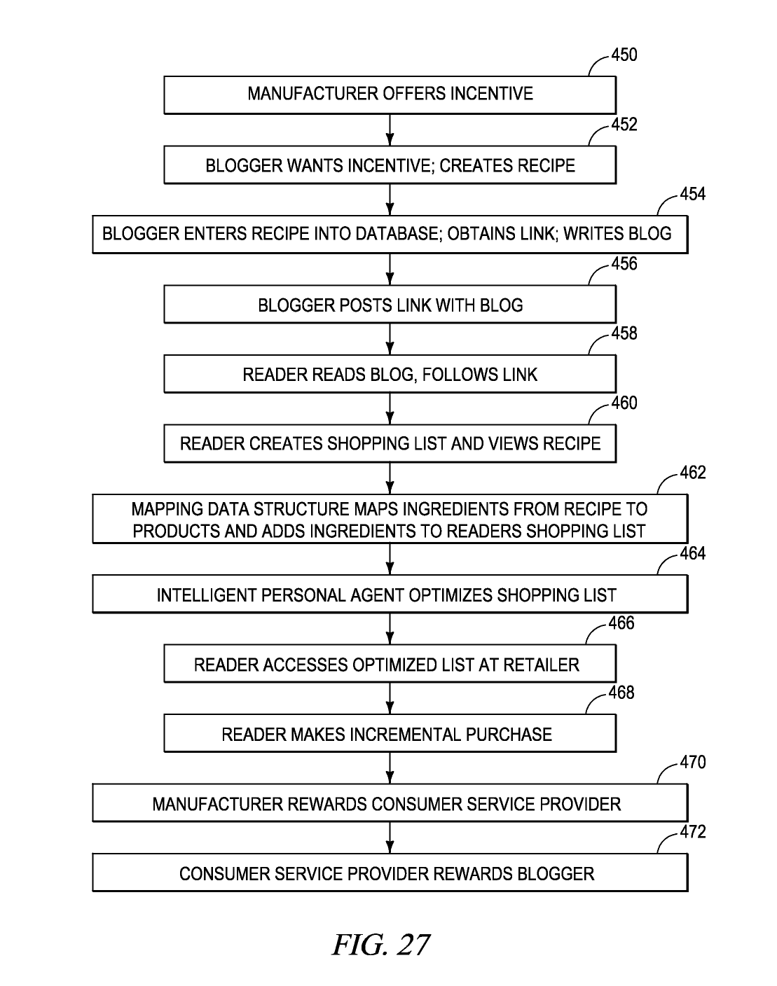

For example, Betty Crocker® wants to stimulate sales of a new flavor of cake mix, caramel apple spice. Betty Crocker® offers a fee payable each time recipe 292 using the branded caramel apple spice cake mix causes product 410 to be put on shopping list 198 of consumer 42. FIG. 27 shows how recipe sharing enabled by consumer service provider 52 generates an incremental purchase of branded product 410. In step 450, Betty Crocker® offers the incentive. Consumer service provider 52 announces the incentive. In step 452, Blogger 446 hears about the incentive and decides to create recipe 292. Blogger 446 has a following of readers devoted to cake pops. Blogger 446 creates new recipe 292 for cake pops using branded product 410. In step 454, blogger 446 adds recipe 292 including ingredient 402 Betty Crocker® brand caramel apple spice cake mix to recipe database 58. Blogger 446 may enable or disable brand substitution. Consumer service provider 52 generates URL link 106 to recipe 292 on website 100. In step 456, blogger 446 places link 106 to recipe 292 on blog 448 describing the new cake pops and encouraging readers to try making the cake pops.

In step 458, a reader reads blog 448, decides to make the cake pops, and clicks on link 106. In step 460, the reader is redirected to individual recipe webpage 340 of website 100 displaying recipe 292 for cake pops. The reader may need to create an account to access website 100. The reader imports ingredient list 356 from recipe 292 onto shopping list 198. Ingredient list 356 includes ingredient 402, a box of caramel apple spice cake mix. In step 462, mapping data structure 114 analyzes ingredients 402-406, searches product database 56, and generates product sets 116 corresponding to each ingredient. If brand substitution is disabled, mapping data structure 114 will select only product 410 Betty Crocker® brand caramel apple spice cake mix to add to product set 116. If brand substitution is enabled, mapping data structure 114 may also select an alternate cake mix product 412, for example, generic spice cake mix to add to product set 116. In step 464, intelligent personal agent 54 creates optimized shopping list 110 based on shopping list 198 for the reader. In step 466, the reader accesses optimized shopping list 110 while at retailer 46. For example, the reader prints out optimized shopping list 110 and carries the print out into local retailer 46. In step 468, the reader makes an incremental purchase of product 410 Betty Crocker® brand caramel apple spice cake mix at retailer 46. In step 470, consumer service provider 52 receives a fee from Betty Crocker® each time the readers follow link 106 to recipe 292 on website 100 and place product 410 Betty Crocker® brand caramel apple spice cake mix on shopping list 198. Alternatively, Betty Crocker® pays a fee each time recipe 292 using ingredient 402 Betty Crocker® brand caramel apple spice cake mix is viewed or shared. Alternatively, the fee comes from a brand's parent company, such as General Mills®. In step 472, consumer service provider 52 rewards blogger 446, either by sharing a portion of the fee collected or in some other way. Manufacturers 22 of non-edible grocery products 410-414 also benefit from the boom in online list 73 sharing enabled by consumer service provider 52.

Blogger 446 may have a following devoted to household products 410-414 unrelated to cooking. For example, blogger 446 is well known for organizing or cleaning tips. Manufacturer 22 of cleaning products 410-414, such as Clorox® Clean-Up® brand cleanser with bleach, creates an incentive for blogger 446 to write about specific branded cleaning product 410 and post link 106 to shared list 108 containing specific branded cleaning product 410 on blog 448. Blogger 446 learns about the incentive from consumer service provider 52. Blogger 446 builds shopping list 108 of cleaning items 112 including Clorox® Clean-Up® brand cleanser with bleach. Consumer service provider 52 creates link 106 to shared list 108 including branded item 112. Blogger 446 writes blog 448 featuring Clorox® Clean-Up® brand cleanser with bleach. Blogger 446 posts blog 448 and link 106 to shared list 108 online.

A reader reads blog 448 and follows link 106 to website 100. The reader may need to create an account to access website 100. The reader imports shared list 108 of cleaning items 112 including Clorox® Clean-Up® brand cleanser with bleach onto shopping list 198. The reader builds combined shopping list 198 by adding items 112. The reader sets item attributes 118 and weighting factors for each item 112 on shopping list 198. Intelligent personal agent 54 optimizes combined shopping list 198 by selecting the optimal product 18 from each product set 116. The reader accesses optimized shopping list 110 including product 410 Clorox® Clean-Up® brand cleanser with bleach while at retailer 46 and makes an incremental purchase of branded product 410. Consumer service provider 52 receives a fee from manufacturer 22 each time readers follow link 106 to shared list 108 on website 100 and place branded cleaning products 410-414 on optimized shopping list 110. Alternatively, manufacturer 22 pays a fee each time list 108 including branded cleaning products 410-414 is viewed or shared. Alternatively, the fee comes from the parent company of manufacturer 22. Consumer service provider 52 rewards blogger 446, either by sharing a portion of the fee collected or in some other way.

Non-profit organizations and other groups also contribute recipes 292-296 and lists 108. Groups promote lists 108 specific to the goals of the organization, with or without seeking compensation. For example, an environmental non-profit group posts link 106 on the website of the environmental group to shared list 108 of spring-cleaning items 112 consisting of renewable, earth friendly products. The non-profit may or may not wish to be compensated when consumer 42 follows link 106, adds earth friendly items 112 from shared list 108 to shopping lists 198, optimizes shopping lists 110 to find local retailers 46-50 offering the best value for the earth friendly spring-cleaning products 410-414, and buys the products from retailers 46-50.

In summary, consumers 42-44, retailers 46-50, manufactures 22, and distributors 26 post lists 73 and recipes 74 to website 100 of consumer service provider 52. Consumer service provider 52 generates links 106 to shared lists 73 and recipes 74. Consumers 42-44, retailers 46-50, manufactures 22, and distributors 26 post links 106 online where more consumers 14 and 34 see them. New consumers 14 and 34 follow links 106 to website 100 of consumer service provider 52 and create shopping lists 198 including items 112 from shared lists 73 and recipes 74. Lists 198 are optimized using data from retailers 46-50 local to each new consumer 14 and 34. New consumers 14 and 34 patronize local retailers 46-50 and make incremental purchases of products 410-414 using optimized shopping lists 110 including the products interchangeable with items on shared lists 73 and recipes 74. Thus, consumer service provider 52 in part controls commerce system 40 by harnessing the power of list 73 and recipe 74 sharing online and influencing consumers 14 and 34 to make incremental purchases of products 410-414 from shared lists 73 and recipes 74 at local retailers 46-50.

In the business transactions between consumers 42-44 and retailers 46-50, consumer service provider 52 plays an important role in terms of increasing sales for retailer 46, while providing consumer 42 with the most value for the money, i.e., creating a win-win scenario. More specifically, intelligent personal agent 54 enables consumers 42-44 to benefit from the boom in recipe 74 and list 73 sharing online. Consumers 42-44 profit from posting popular recipes 292-296 or lists 108 online. Consumers 42-44 easily find new recipes 292-296 using new healthful ingredients, leading to consumers 42-44 more readily adding new healthful ingredients to their menus. Consumers 42-44 more readily try new recipes 292-296 posted online. Consumers 42-44 import shared lists 108 and shared ingredient lists 356 from shared recipes 74 onto combined shopping lists 198. Intelligent personal agent 54 finds the best local price for products 410-414 on optimized shopping list 110, as well as aisle and shelf locations for the unfamiliar products, using data from product database 56, maintained by consumer service provider 52.

Retailer 30, manufacturer 22, and distributor 26 capitalize on the boom in recipe 74 and list 73 sharing online. Retailer 30, manufacturer 22, and distributor 26 target marketing funding by providing rewards only to those efforts that directly result in incremental purchases of the desired branded products 410-414. No marketing money is wasted.

Intelligent personal agent 54 helps consumers 42-44 quantify and evaluate, from a myriad of potential products 410-414 on the market from competing retailers 46-50, a smaller, optimized shopping list 110 objectively and analytically selected to meet consumers' needs and ensure variety while providing the best value. Consumers 42-44 rely on intelligent personal agent 54 as having produced a comprehensive, reliable, and objective shopping list 110 in view of the profile of consumer 42 and weighted product preferences, as well as retailer product information, that yields the optimal purchasing decision to the benefit of consumer 42. While consumer 42 makes the decision to place product 410 in the basket for purchase, he or she comes to rely upon, or at least consider, the recommendations from consumer service provider 52. The consumer model generated by intelligent personal agent 54 thus in part controls many of the purchasing decisions and other aspects of commercial transactions and related activities within commerce system 40.

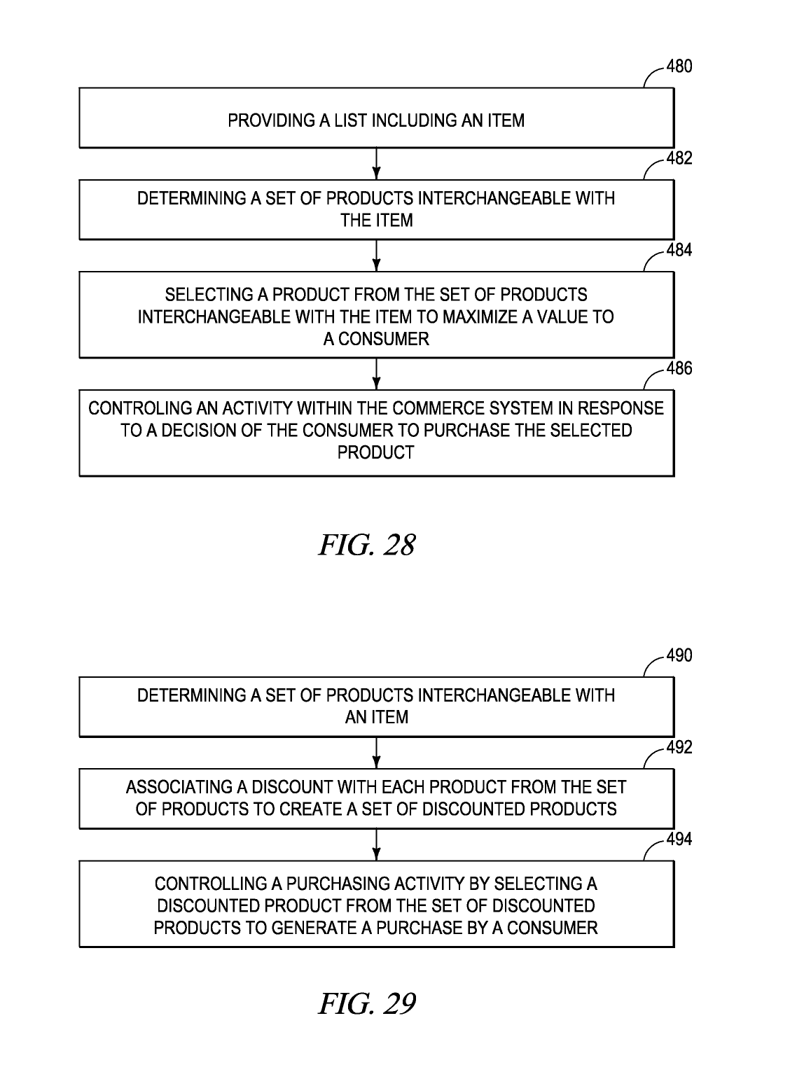

FIG. 28 shows a process for controlling an activity within a commerce system by enabling a consumer to purchase a selected product interchangeable with an item from a list. In step 480, a list including an item is provided. The list may be a consumer generated list, a shared list, or an ingredient list. In step 482, a set of products interchangeable with the item is determined. In step 484, a product is selected from the set of products to maximize the value to a consumer. In step 486, an activity within the commerce system is controlled in response to a decision of the consumer to purchase the selected product.

FIG. 29 shows a process for controlling a purchasing decision by selecting a discounted product to generate a purchase by a consumer. In step 490, a set of products interchangeable with an item is determined. In step 492, a discount is associated with each product in the set of products to create a set of discounted products. In step 492, a purchasing activity is controlled by selecting a discounted product from the set of discounted products to generate a purchase by a consumer.

In summary, consumer service provider 52 in part controls the movement of goods between members of the commerce system 40. Retailers 46-50 offer products 410-414 for sale. Consumers 42-44 make decisions to purchase products 410-414. Consumers 42-44 share lists 108 and recipes 292-296. Consumer service provider 52 offers consumers 42-44 comparative shopping services, to aid consumer 42 in making purchasing decisions. In particular, consumer service provider 52 assists consumers 42-44 to incorporate shared lists 108 and recipes 292-296 into the consumers' shopping. Consumer service provider 52 presents items 112 on shared list 108 to consumer 42. Mapping data structure 114 generates product sets 116 corresponding to items 112 on shared list 108. The presentation of products 410-414 interchangeable with items 112 from shared list 108 includes comparative product information from multiple retailers 46-50. Intelligent personal agent 54 optimizes shopping list 198 based on the product information and weighted preferences for the item attributes 118 for the product families and specific requirements of consumer 42. Optimized shopping list 110 is made available to consumer 42 to assist with purchasing decisions. Optimized shopping list 110 helps consumer 42 to make the purchasing decision based on comprehensive, reliable, and objective retailer product information. Consumer 42 makes purchases within the commerce system 40 based on optimized shopping list 110 including products 410-414 selected from product sets 116 corresponding to items 112 from shared list 108. Consumer service provider 52 controls an activity within commerce system 40 when consumer 42 purchases the goods based on the recommendations of consumer service provider and intelligent personal agent 54. By following the recommendations from consumer service provider 52, consumer 42 receives the most value for the money. Consumer service provider 52 becomes the preferred source of retail information for consumer 42, i.e., an aggregator of retailers 46-50 capable of providing one-stop shopping.

While one or more embodiments of the present invention have been illustrated in detail, the skilled artisan will appreciate that modifications and adaptations to the embodiments may be made without departing from the scope of the present invention as set forth in the following claims.

What is claimed:

1. A method of controlling an activity within a commerce system, comprising:
providing a list including an item;
determining a set of products interchangeable with the item;
selecting a product from the set of products to maximize a value to a consumer; and
controlling the activity within the commerce system in response to a decision by the consumer to purchase the selected product.

2. The method of claim 1, wherein determining the set of products includes comparing a first attribute of the item to a second attribute of an interchangeable product.

3. The method of claim 1, wherein determining the set of products includes accessing data associated with a plurality of interchangeable products via an intelligent personal agent.

4. The method of claim 1, further including selecting the product based on a preference or a requirement defined by the consumer.

5. The method of claim 1, further including selecting the product based on a discount associated with the product.

6. The method of claim 1, wherein selecting the product includes identifying a local retailer selling the selected product.

7. A method of controlling an activity within a commerce system, comprising:
providing an item;
determining a set of products interchangeable with the item;
selecting a product from the set of products to meet a consumer satisfaction threshold; and
controlling the activity within the commerce system in response to a decision by the consumer to purchase the selected product.

8. The method of claim 7, wherein determining the set of products includes comparing a first attribute of the item to a second attribute of an interchangeable product.

9. The method of claim 7, wherein determining the set of products includes accessing an intelligent personal agent.

10. The method of claim 7, further including selecting the product based on a preference or a requirement defined by the consumer.

11. The method of claim 7, further including selecting the product based on a discount associated with the product.

12. The method of claim 7, wherein selecting the product includes selecting a local retailer selling the selected product.

13. The method of claim 7, further including providing a list wherein the list includes the item.

14. A method of controlling a purchasing activity, comprising:
determining a set of products interchangeable with an item;
associating a discount with each product from the set of products to create a set of discounted products; and
controlling the purchasing activity by selecting a discounted product from the set of discounted products for purchase by a consumer.

15. The method of claim 14, wherein determining the set of products includes comparing a first attribute of the item to a second attribute of an interchangeable product.

16. The method of claim 14, wherein determining the set of products includes accessing data associated with a plurality of interchangeable products via an intelligent personal agent.

17. The method of claim 14, further including selecting the discounted product based on a preference defined by the consumer.

18. The method of claim 14, further including selecting the discounted product based on a requirement defined by the consumer.

19. The method of claim 14, wherein selecting the discounted product includes selecting a local retailer selling the selected product.

20. A computer program product usable with a programmable computer processor having a computer readable program code embodied in a non-transitory computer usable medium for controlling an activity within a commerce system, comprising:
providing an item;
determining a set of products interchangeable with the item;
selecting a product from the set of products to meet a consumer satisfaction threshold; and
controlling the activity within the commerce system in response to a decision by the consumer to purchase the selected product.

21. The computer program product of claim 20, wherein determining the set of products includes comparing a first attribute of the item to a second attribute of an interchangeable product.

22. The computer program product of claim 20, wherein determining the set of products includes accessing an intelligent personal agent.

23. The computer program product of claim 20, further including selecting the product based on a preference or a requirement defined by the consumer.

24. The computer program product of claim 20, further including selecting the product based on a discount associated with the product.

25. The computer program product of claim 20, wherein selecting the product includes identifying a local retailer selling the selected product.
